(19) United States
(12) Patent Application Publication
(10) Pub. No.: US 2020/0012998 A1
(43) Pub. Date: Jan. 9, 2020

(54) CONCEPTS FOR MONITORING DELIVERED ITEMS

(71) Applicant: United Parcel Service of America, Inc., Atlanta, GA (US)

(72) Inventors: Robert J. Gillen, Alpharetta, GA (US); Kenneth Bradley Gubler, Marietta, GA (US); Juan Perez, Atlanta, GA (US)

(21) Appl. No.: 16/573,021

(22) Filed: Sep. 17, 2019

Related U.S. Application Data
(63) Continuation-in-part of application No. 16/221,031, filed on Dec. 14, 2018.
Application No. 16/221,031 is a continuation of application No. 14/548,389, filed on Nov. 20, 2014, now Pat. No. 10,192,190.
(60) Provisional application No. 61/906,511, filed on Nov. 20, 2013.

(51) Int. Cl. G06Q 10/08; G06Q 50/28; G06Q 10/06

(52) U.S. Cl. CPC G06Q 10/083; G06Q 10/08; G06Q 10/063114; G06Q 50/28

(57) ABSTRACT

Computer program products, methods, systems, apparatus, and computing entities are provided. In one embodiment, a connection between an electronic door hanger and a customer computing entity can be established at a customer's location. With a connection established, information about an attempted (e.g., successful/unsuccessful) pick-up or delivery can be automatically provided to the customer computing entity.

### CROSS-REFERENCE TO RELATED APPLICATIONS

This application is a continuation-in-part of U.S. application Ser. No. 16/221,031, filed on 14 Dec. 2018 and entitled “Concepts for Electronic Door Hangers,” which is continuation of U.S. Nonprovisional application Ser. No. 14/548,389, filed on 20 Nov. 2014 and entitled “Concepts for Electronic Door Hangers,” which claims priority to U.S. Provisional Application No. 61/906,511, filed on 20 Nov. 2013, each of which is hereby incorporated herein in its entirety by reference.

### BACKGROUND

With the increasing demand of customer-focused pick-ups and deliveries of items, new technologies are needed for communicating relevant information to customers in a timely and easy to use manner.

### BRIEF SUMMARY

In general, embodiments of the present invention provide methods, apparatus, systems, computing devices, computing entities, and/or the like for providing notifications using electronic door hangers.

In accordance with one aspect, a method is provided. In one embodiment, the method comprises (1) responsive to a connection button associated with a customer computing entity being activated, automatically establishing a connection between an electronic door hanger and the customer computing entity within a configurable time period; and (2) responsive to automatically establishing the connection between the electronic door hanger and the customer computing entity, automatically providing, via a user computing entity operated by a carrier operator at the customer's location, a notification regarding a pick-up or a delivery of an item to the customer computing entity.

In accordance with yet another aspect, a system comprising a user computing entity and an electronic door hanger is provided. In one embodiment, the system is configured to (1) responsive to a connection button associated with a customer computing entity being activated, automatically establish, via the electronic door hanger, a connection between an electronic door hanger and the customer computing entity within a configurable time period; and (2) responsive to automatically establishing the connection between the electronic door hanger and the customer computing entity, automatically provide, via the user computing entity operated by a carrier operator at the customer's location, a notification regarding a pick-up or a delivery of an item to the customer computing entity.

In accordance with one aspect, a method is provided. In one embodiment, the method comprises (1) monitoring a location of an electronic door hanger, a location of a customer computing entity, or both, wherein (a) a customer associated with the customer computing entity is registered for notification services and (b) the electronic door hanger is placed at the customer's location; (2) determining whether the electronic door hanger and the customer computing entity are within a configurable distance from each other; and (3) responsive to determining that the electronic door hanger and the customer computing entity are within the configurable distance from each other, automatically providing a notification regarding a pick-up or a delivery of an item to an electronic destination address associated with the customer's notification preferences.

In accordance with another aspect, a computer program product is provided. The computer program product may comprise at least one computer-readable storage medium having computer-readable program code portions stored therein, the computer-readable program code portions comprising executable portions configured to (1) monitor a location of an electronic door hanger, a location of a customer computing entity, or both, wherein (a) a customer associated with the customer computing entity is registered for notification services and (b) the electronic door hanger is placed at the customer's location; (2) determine whether the electronic door hanger and the customer computing entity are within a configurable distance from each other; and (3) responsive to determining that the electronic door hanger and the customer computing entity are within the configurable distance from each other, automatically provide a notification regarding a pick-up or a delivery of an item to an electronic destination address associated with the customer's notification preferences.

In accordance with yet another aspect, an apparatus comprising at least one processor and at least one memory including computer program code is provided. In one embodiment, the at least one memory and the computer program code may be configured to, with the processor, cause the apparatus to (1) monitor a location of an electronic door hanger, a location of a customer computing entity, or both, wherein (a) a customer associated with the customer computing entity is registered for notification services and (b) the electronic door hanger is placed at the customer's location; (2) determine whether the electronic door hanger and the customer computing entity are within a configurable distance from each other; and (3) responsive to determining that the electronic door hanger and the customer computing entity are within the configurable distance from each other, automatically provide a notification regarding a pick-up or a delivery of an item to an electronic destination address associated with the customer's notification preferences.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier/transporter computing entity according to one embodiment of the present invention.

FIG. 3 is an exemplary schematic diagram of a customer computing entity according to one embodiment of the present invention.

FIGS. 4A, 4B, 4C, 4D, 4E, 4F, and 4G are electronic door hangers according to one embodiment of the present invention.

FIGS. 5A and 5B are flowcharts illustrating operations and processes that can be used in accordance with various embodiments of the present invention.

FIGS. 6-8 are exemplary input and output produced with various embodiments of the present invention.

FIG. 9 depicts an example environment according to an embodiment of the present invention.

FIG. 10 depicts an example alert at a user device according to an embodiment of the present invention.

FIG. 11 depicts an example alert at a user device according to an embodiment of the present invention.

FIG. 12 depicts an example method in accordance with an embodiment of the present invention.

FIG. 13 depicts an example application in accordance with an embodiment of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

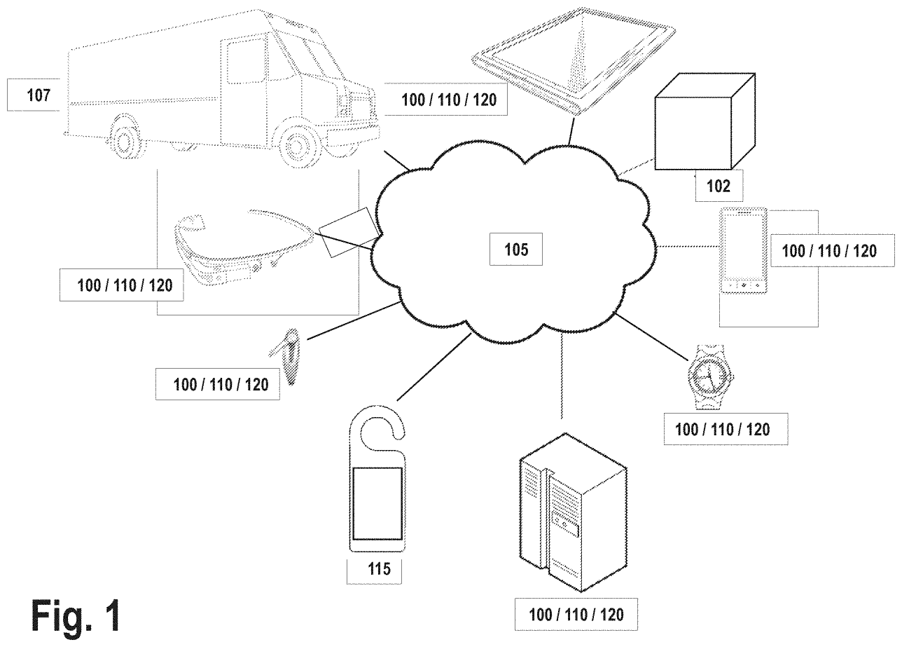

FIG. 1 provides an illustration of an exemplary embodiment of the present invention. As shown in FIG. 1, this particular embodiment may include one or more carrier/transporter computing entities 100, one or more items 102, one or more networks 105, one or more vehicles 107, one or more customer computing entities 110, one or more electronic door hangers 115, one or more user computing entities 120, and/or the like. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

1. Exemplary Carrier/Transporter Computing Entity

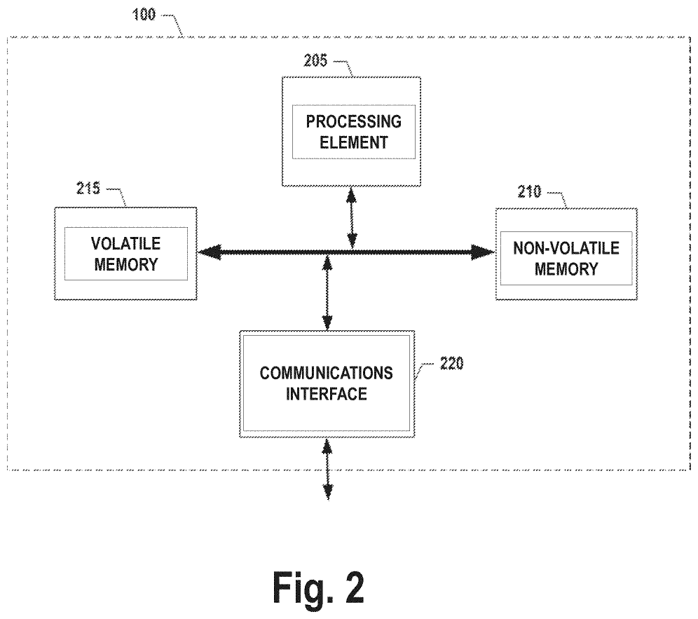

FIG. 2 provides a schematic of a carrier/transporter computing entity 100 according to one embodiment of the present invention. A carrier may be a traditional carrier, such as United Parcel Service (UPS), FedEx, DHL, courier services, the United States Postal Service (USPS), Canadian Post, freight companies (e.g. truck-load, less-than-truckload, rail carriers, air carriers, ocean carriers, etc.), and/or the like. However, a carrier may also be a nontraditional carrier, such as Amazon, Google, Uber, ride-sharing services, crowd-sourcing services, retailers, and/or the like. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the carrier/transporter computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the carrier/transporter computing entity 100 may communicate with customer computing entities 110, electronic door hangers 115, user computing entities 120, and/or the like.

As shown in FIG. 2, in one embodiment, the carrier/transporter computing entity 100 may include or be in communication with one or more processing elements 205 (also referred to as processors, processing circuitry, processing device, and/or similar terms used herein interchangeably) that communicate with other elements within the carrier/transporter computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coproces sing entities, application specific instruction-set processors (AS IPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the carrier/transporter computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The terms database, database instance, database management system, and/or similar terms used herein interchangeably may refer to a structured collection of records or data that is stored in a computer-readable storage medium, such as via a relational database, hierarchical database, and/or network database.

In one embodiment, the carrier/transporter computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the carrier/transporter computing entity 100 with the assistance of the processing element 205 and operating system.

As indicated, in one embodiment, the carrier/transporter computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier/transporter computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Bluetooth protocols, Wibree, Home Radio Frequency (HomeRF), Simple Wireless Abstract Protocol (SWAP), wireless universal serial bus (USB) protocols, and/or any other wireless protocol.

Although not shown, the carrier/transporter computing entity 100 may include or be in communication with one or more input elements, such as a keyboard input, a mouse input, a touch screen/display input, motion input, movement input, audio input, pointing device input, joystick input, keypad input, and/or the like. The carrier/transporter computing entity 100 may also include or be in communication with one or more output elements (not shown), such as audio output, video output, screen/display output, motion output, movement output, and/or the like. Further, an electronic door hanger 115 may have a locking/unlocking mechanism that can be activated/deactivated remotely or locally by a carrier/transporter computing entity 100, customer computing entity 110, and/or user computing entity 120.

As will be appreciated, one or more of the carrier/transporter computing entity's 100 components may be located remotely from other carrier/transporter computing entity 100 components, such as in a distributed system. Furthermore, one or more of the components may be combined and additional components performing functions described herein may be included in the carrier/transporter computing entity 100. Thus, the carrier/transporter computing entity 100 can be adapted to accommodate a variety of needs and circumstances. As will be recognized, these architectures and descriptions are provided for exemplary purposes only and are not limiting to the various embodiments.

2. Exemplary Vehicle

In various embodiments, the term vehicle 107 is used generically. For example, a carrier/transporter vehicle 107 may be a manned or an unmanned tractor, a truck, a car, a motorcycle, a moped, a Segway, a bicycle, a golf cart, a hand truck, a cart, a trailer, a tractor and trailer combination, a van, a flatbed truck, a vehicle, a drone, an airplane, a helicopter, a boat, a barge, and/or any other form of object for moving or transporting people and/or items (e.g., one or more packages, parcels, bags, containers, loads, crates, items banded together, vehicle parts, pallets, drums, the like, and/or similar words used herein interchangeably). In one embodiment, each vehicle 107 may be associated with a unique vehicle identifier (such as a vehicle ID) that uniquely identifies the vehicle 107. The unique vehicle ID (e.g., trailer ID, tractor ID, vehicle ID, and/or the like) may include characters, such as numbers, letters, symbols, and/or the like. For example, an alphanumeric vehicle ID (e.g., “AS”) may be associated with each vehicle 107. In another embodiment, the unique vehicle ID may be the license plate, registration number, or other identifying information assigned to the vehicle 107.

Various computing entities, devices, and/or similar words used herein interchangeably can be associated with the vehicle 107, such as a data collection device or other computing entities. In general, the terms computing entity, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, key fobs, RFID tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The data collection device may collect telematics data (including location data) and transmit/send the data to the mobile computing entity, the mapping computing entity, and/or various other computing entities via one of several communication methods.

In one embodiment, the data collection device may include, be associated with, or be in wired or wireless communication with one or more processors (various exemplary processors are described in greater detail below), one or more location-determining devices or one or more location sensors (e.g., Global Navigation Satellite System (GNSS) sensors), one or more telematics sensors, one or more real-time clocks, a J-Bus protocol architecture, one or more electronic control modules (ECM), one or more communication ports for receiving telematics data from various sensors (e.g., via a CAN-bus), one or more communication ports for transmitting/sending data, one or more RFID tags/sensors, one or more power sources, one or more data radios for communication with a variety of communication networks, one or more memory modules 410, and one or more programmable logic controllers (PLC). It should be noted that many of these components may be located in the vehicle 107 but external to the data collection device.

In one embodiment, the one or more location sensors, modules, or similar words used herein interchangeably may be one of several components in wired or wireless communication with or available to the data collection device. Moreover, the one or more location sensors may be compatible with Global Positioning System (GPS) satellites, such as Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, triangulation may be used in connection with a device associated with a particular vehicle 107 and/or the vehicle's operator and with various communication points (e.g., cellular towers or Wi-Fi access points) positioned at various locations throughout a geographic area to monitor the location of the vehicle 107 and/or its operator. The one or more location sensors may be used to receive latitude, longitude, altitude, heading or direction, geocode, course, position, time, and/or speed data (e.g., referred to herein as telematics data and further described herein below). The one or more location sensors may also communicate with the mapping computing entity, the data collection device, mobile computing entity, and/or similar computing entities.

As indicated, in addition to the one or more location sensors, the data collection device may include and/or be associated with one or more telematics sensors, modules, and/or similar words used herein interchangeably. For example, the telematics sensors may include vehicle sensors, such as engine, fuel, odometer, hubometer, tire pressure, location, weight, emissions, door, and speed sensors. The telematics data may include, but is not limited to, speed data, emissions data, revolutions per minute engine (RPM) data, tire pressure data, oil pressure data, seat belt usage data, distance data, fuel data, idle data, and/or the like (e.g., referred to herein as telematics data). The telematics sensors may include environmental sensors, such as air quality sensors, temperature sensors, and/or the like. Thus, the telematics data may also include carbon monoxide (CO), nitrogen oxides (NOx), sulfur oxides (SOx), Ethylene Oxide (EtO), ozone (O3), hydrogen sulfide (H2S) and/or ammonium (NH4) data, and/or meteorological data (e.g., referred to herein as telematics data).

In one embodiment, the ECM may be one of several components in communication with and/or available to the data collection device. The ECM, which may be a scalable and subservient device to the data collection device, may have data processing capability to decode and store analog and digital inputs from vehicle systems and sensors. The ECM may further have data processing capability to collect and present telematics data to the J-Bus (which may allow transmission to the data collection device), and output standard vehicle diagnostic codes when received from a vehicle's J-Bus-compatible on-board controllers 440 and/or sensors. As indicated, a communication port may be one of several components available in the data collection device (or be in or as a separate computing entity). Embodiments of the communication port may include an Infrared data Association (IrDA) communication port, a data radio, and/or a serial port. The communication port may receive instructions for the data collection device. These instructions may be specific to the vehicle 107 in which the data collection device is installed, specific to the geographic area in which the vehicle 107 will be traveling, specific to the function the vehicle 107 serves within a fleet, and/or the like. In one embodiment, the data radio may be configured to communicate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, WiMAX, UWB, IR, NFC, Bluetooth, USB, Wibree, HomeRF, SWAP, and/or the like. Similarly, the customer computing entity 110 may operate in accordance with multiple wired communication standards and protocols, such as those described above with regard to the carrier/transporter computing entity 100 via a network interface 320.

3. Exemplary Item

An item/shipment 102 may be any tangible and/or physical object. Such items/shipments 102 may be picked up and/or delivered by a carrier/transporter. In one embodiment, an item/shipment 102 may be or be enclosed in one or more packages, parcels, bags, containers, loads, crates, items banded together, vehicle parts, pallets, drums, the like, and/or similar words used herein interchangeably. Such items 102 may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes. Further, such items 102 may have the capabilities and components of the described with regard to the carrier/transporter computing entities 100, networks 105, vehicles 107, customer computing entities 110, electronic door hangers 115, user computing entities 120, and/or the like. In this regard, in some example embodiments, an item may communicate send “to” address information/data, received “from” address information/data, unique identifier codes, and/or various other information/data. In one embodiment, each item may include an item/shipment identifier, such as an alphanumeric identifier. Such item/shipment identifiers may be represented as text, barcodes, tags, character strings, Aztec Codes, MaxiCodes, Data Matrices, Quick Response (QR) Codes, electronic representations, and/or the like. A unique item/shipment identifier (e.g., 123456789) may be used by the carrier to identify and track the item as it moves through the carrier's transportation network.

Further, such item/shipment identifiers can be affixed to items by, for example, using a sticker (e.g., label) with the unique item/shipment identifier printed thereon (in human and/or machine readable form) or an RFID tag with the unique item/shipment identifier stored therein.

4. Exemplary Customer Computing Entity

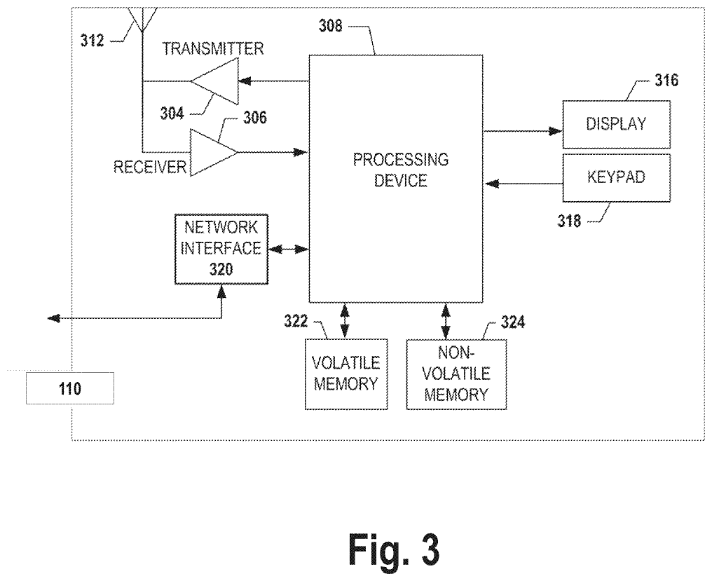

FIG. 3 provides an illustrative schematic representative of a customer computing entity 110 that can be used in conjunction with embodiments of the present invention. In one embodiment, a customer may be a consignor (person sending an item/shipment 102) or a consignee (intended recipient of an item/shipment 102). In one embodiment, a customer computing entity 110 may include one or more components that are functionally similar to those of the carrier/transporter computing entity 100, item 102, vehicle 107, electronic door hanger 115, user computing entity 120, and/or the like. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, key fobs, RFID tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 3, the customer computing entity 110 may include an antenna 312, a transmitter 304 (e.g., radio), a receiver 306 (e.g., radio), and a processing element 308 (e.g., CPLDs, microprocessors, multi-core processors, coprocessing entities, application-specific instruction set processor (ASIP), microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the customer computing entity 110 may be capable of operating with one or more air interface standards, communication protocols, modulation types, and access types. More particularly, the customer computing entity 110 may operate in accordance with any of a number of wireless communication standards and protocols, such as those described above with regard to the carrier/transporter computing entity 100. In a particular embodiment, the customer computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, WiMAX, UWB, IR, NFC, Bluetooth, USB, Wibree, HomeRF, SWAP, and/or the like. Similarly, the customer computing entity 110 may operate in accordance with multiple wired communication standards and protocols, such as those described above with regard to the carrier/transporter computing entity 100 via a network interface 320.

Via these communication standards and protocols, the customer computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The customer computing entity 110 can also download changes, add-ons, and updates, for instance, to its firmware, software (e.g., including executable instructions, applications, program modules), and operating system.

According to one embodiment, the customer computing entity 110 may include a location determining aspects, device, module, functionality, and/or similar words used herein interchangeably. For example, the customer computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using GPS). The satellites may be a variety of different satellites, including LEO satellite systems, DOD satellite systems, the European Union Galileo positioning systems, the Chinese Compass navigation systems, Indian Regional Navigational satellite systems, and/or the like. This data can be collected using a variety of coordinate systems, such as the DD; DMS; UTM; UPS coordinate systems; and/or the like. Alternatively, the location information can be determined/identified by triangulating the customer computing entity's 110 position in connection with a variety of other systems, including cellular towers, Wi-Fi access points, and/or the like. Similarly, the customer computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine/identify the location of someone or something to within inches or centimeters.

The customer computing entity 110 may also comprise a user interface (that can include a display 316 coupled to a processing element 308) and/or a user input interface (coupled to a processing element f). For example, the user interface may be a user application, browser, user interface, and/or similar words used herein interchangeably executing on and/or accessible via the customer computing entity 110 to interact with and/or cause display of information from the carrier/transporter computing entity 100, as described herein. The user input interface can comprise any of a number of devices allowing the customer computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the customer computing entity 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The customer computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the customer computing entity 110. As indicated, this may include a user application that is resident on the entity or accessible through a browser or other user interface for communicating with the carrier/transporter computing entity 100, electronic door hanger 115, and/or various other computing entities.

In another embodiment, the customer computing entity 110 may include one or more components or functionality that are the same or similar to those of the carrier/transporter computing entity 100, as described in greater detail above. As will be recognized, these architectures and descriptions are provided for exemplary purposes only and are not limiting to the various embodiments.

In one embodiment, customer computing entities 110 may be fixed with regard to their geographic locations, such as by being in fixed positions at school entrances, bus stops, mall entrances, aisles of a store, in classrooms, on playgrounds, at intersections, on light poles, in cafeterias or hallways, on bridges, and/or the like. In another embodiment, customer computing entities 110 may be mobile with regard to their geographic locations. For example, one or more of the customer computing entities 110 may be disposed on school buses, worn by school bus drivers, be attached to package delivery vehicles, attached to mobile shipping containers, affixed to shopping carts or wheelchairs, positioned in passenger vehicles, and/or the like. As will be recognized, electronic door hangers 115 may also be mobile with regard to their geographic locations by being carried or worn by the respective users, attached to vehicles, and/or the like. As will be recognized, a variety of other approaches and techniques can be used to adapt to various needs and circumstances.

5. Exemplary Electronic Door Hanger

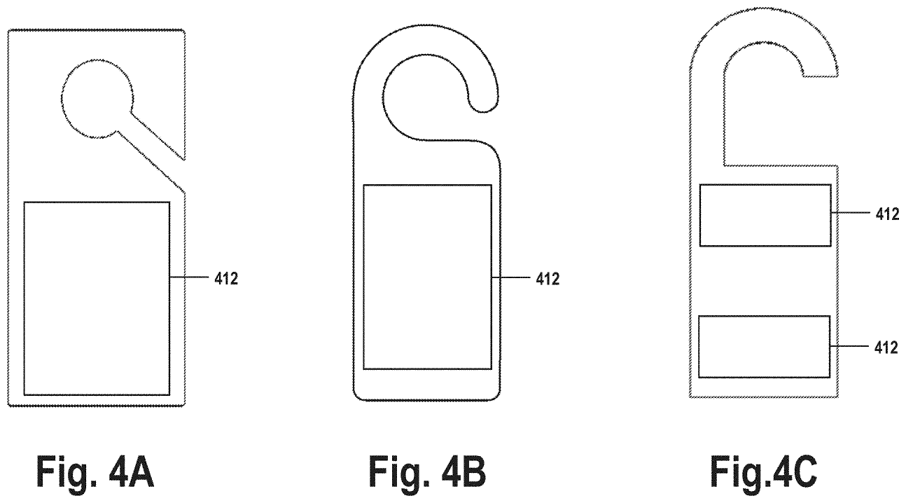

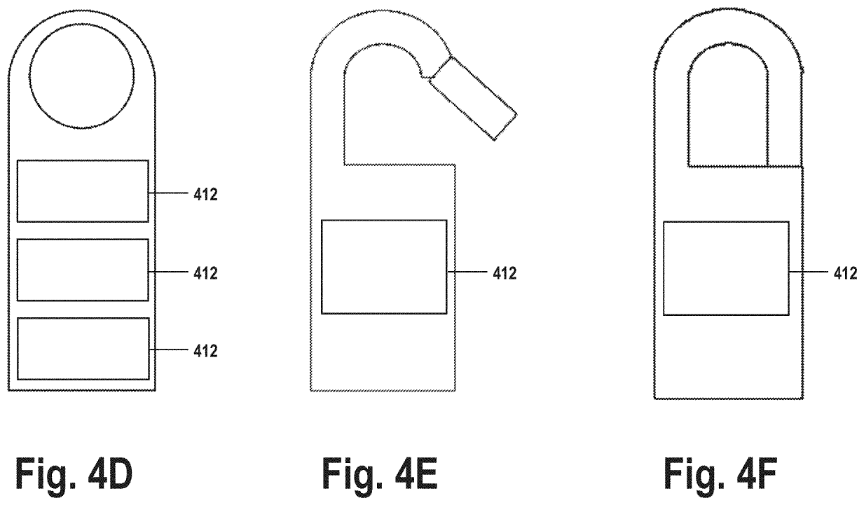

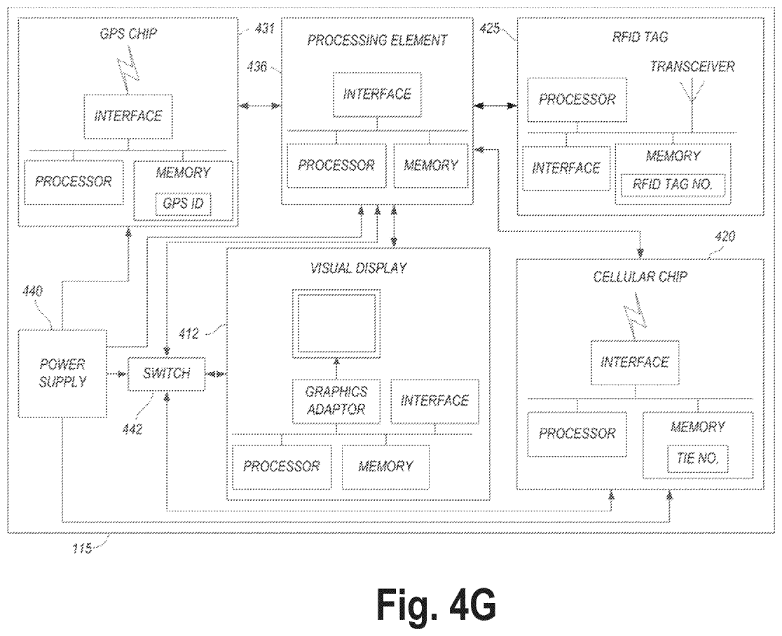

FIGS. 4A-4G represent exemplary depictions of components of an electronic door hanger 115. In one embodiment, an electronic door hanger 115 can be sized and shaped to hang on or around a variety of objects including door knobs, door locks, door levers, other door hardware, posts, fences, mailboxes, lights, and/or the like. FIGS. 4A-4F show particular embodiments in which electronic door hangers 115 are appropriately sized and shaped by molding plastic to hang on or around various objects. The electronic door hangers 115 can be created or molded from one or more plastics, such as Polyethylene Terephthalate (PET or PETE), High Density Polyethylene (HDPE), Plastic Polyvinyl Chloride (PVC), Low Density Polyethylene (LDPE), Polypropylene (PP), Polystyrene (PS), and/or the like. As will be recognized, the electronic door hanger 115 can also include or be made of a variety of other materials as well. In one embodiment, an electronic door hanger 115 (not shown) may also include a pouch that can hold or store various papers (e.g., invoices, receipts, advertisements, and/or the like) and/or comprise one or more labels.

In some embodiments, components of an electronic door hanger 115 may include one or more display areas/portions 412, one or more processing elements 436, one or more location determining aspects 431 (such as those described previously), one or more RFID tags 425, one or more power supplies 440, one or more power switches 442, one or more communications interfaces 420, and/or the like. A communications interface 420 may be a long range (e.g., radio transceiver) or short range (e.g., RFID tag, NFC) communications interface. A communications interface 420 may be capable of communicating in one or more cellular communications protocols, including, but not limited to, UMTS, CDMA2000, 1×RTT, WCDMA, TD-SCDMA, LTE, E-UTRAN, EVDO, HSPA, HSDPA, Wi-Fi, WiMAX, UWB, IR, NFC, Bluetooth, USB, Wibree, HomeRF, SWAP, and/or the like. The communications interface 420 may allow the electronic door hanger to communicate with carrier/transporter computing entities 100, customer computing entities 110, user computing entities 120, and/or the like. In certain embodiments, this may allow a carrier/transporter computing entity 100 (or other computing entity) to remotely wipe (e.g., delete) any information/data from the electronic door hanger 115. This may also allow the electronic door hanger 115 to establish connections and communicate with customer computing entities 110.

A communications interface 420 may be connected to a processing element 436 to transmit shipping information/data to the processing element 436 so that the information/data may be translated into a format that may be capable of being displayed on a display area/portion 412. A display area/portion 412 may be connected to a processing element 436 so that the display area/portion 412 may receive shipping information/data that is to be displayed. A display area/portion 412 may refer to any type of updateable electronic display, whether black and white or color, such as Gyricon, electrophoretic display, electrowetting display, Light-emitting diode (LED) display, liquid crystal display (LCD), bistable LCD, electronic paper display, or any similar type of updateable electronic display. A display area/portion 412 may further include displays such as electrochromic displays, printed electronic displays, or displays manufactured using organic electronics or plastics electronics and using materials such as conductive polymers, plastics, and small molecules.

A power supply 440 may be one of many types of power supplies, including a battery, a power sheet, photoelectric cell, and the like. Such power supplies 440 may be lightweight, flexible, and ultra-thin. Nevertheless, power supplies that are not lightweight, flexible, and/or ultra-thin may also be utilized in an electronic door hanger 115.

A power switch 442 may be any switch that may change the flow of the current or voltage applied by a power supply 440 to a display area/portion 412. A power switch 442 may be selectively activated by a processing element 436 in order to provide power to illuminate a display area/portion 412. As will be recognized, a variety of other approaches and techniques can be used to adapt to various needs and circumstances.

An electronic door hanger 115 may have a variety of other features and functionality, including those described in U.S. Pat. No. 7,511,617 and U.S. Publ. No. 2009-0319078, which are hereby incorporated herein in their entireties by reference.

6. Exemplary User Computing Entity

In one embodiment, a user computing entity 120 may be operated by carrier/transporter personnel/operator (e.g., picking up and/or delivering items to customers). In one embodiment, a user computing entity 120 may include one or more components that are functionally similar to those of the carrier/transporter computing entity 100, the customer computing entity 110, the electronic door hanger 115, and/or the like. For example, in one embodiment, each user computing entity 120 may include one or more processing elements (e.g., CPLDs, microprocessors, multi-core processors, coprocessing entities, ASIP s, microcontrollers, and/or controllers), one or more display device/input devices (e.g., including user interfaces), volatile and non-volatile storage or memory, and/or one or more communications interfaces. For example, the user interface may be a user application, browser, user interface, interface, and/or similar words used herein interchangeably executing on and/or accessible via the user computing entity 120 to interact with and/or cause display of information, as described herein. This may also enable the user computing entity 120 to communicate with various other computing entities, such as carrier/transporter computing entities, customer computing entities 110, electronic door hangers 115, and/or various other computing entities. As will be recognized, these architectures and descriptions are provided for exemplary purposes only and are not limiting to the various embodiments.

### III. Exemplary System Operation

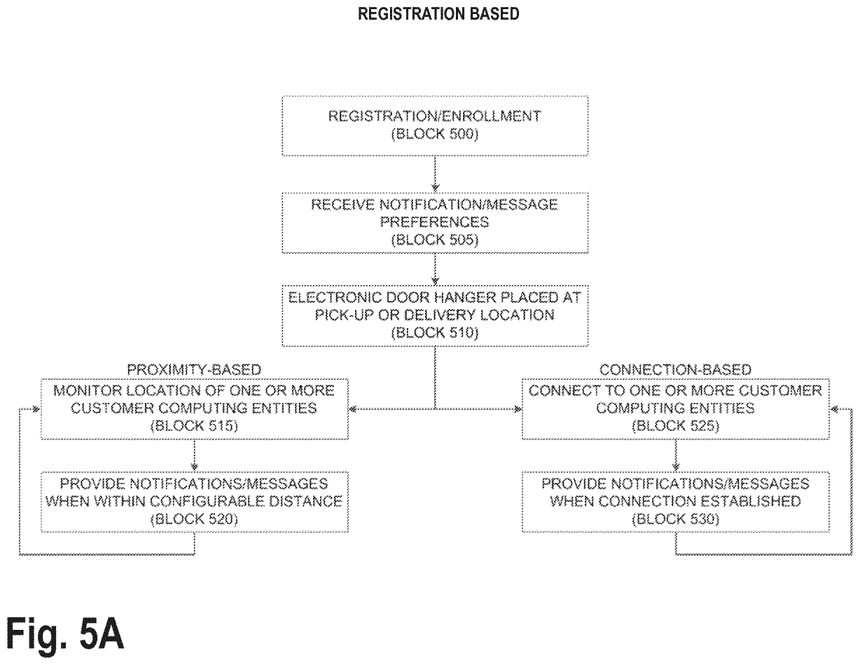

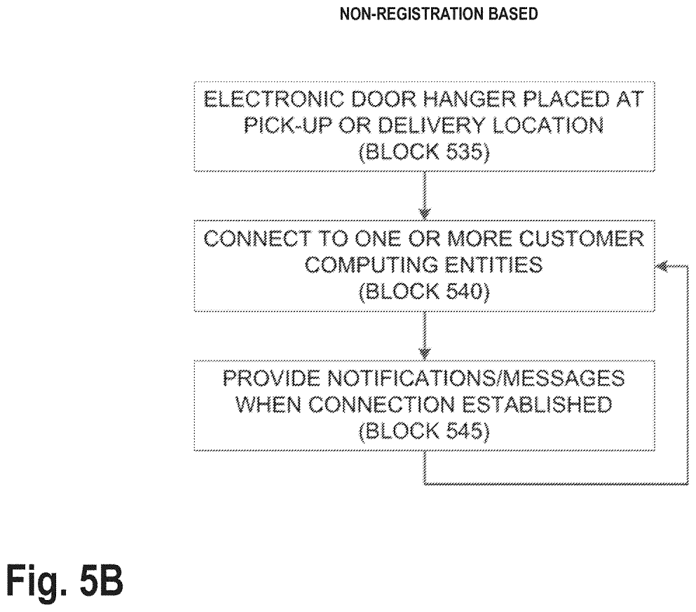

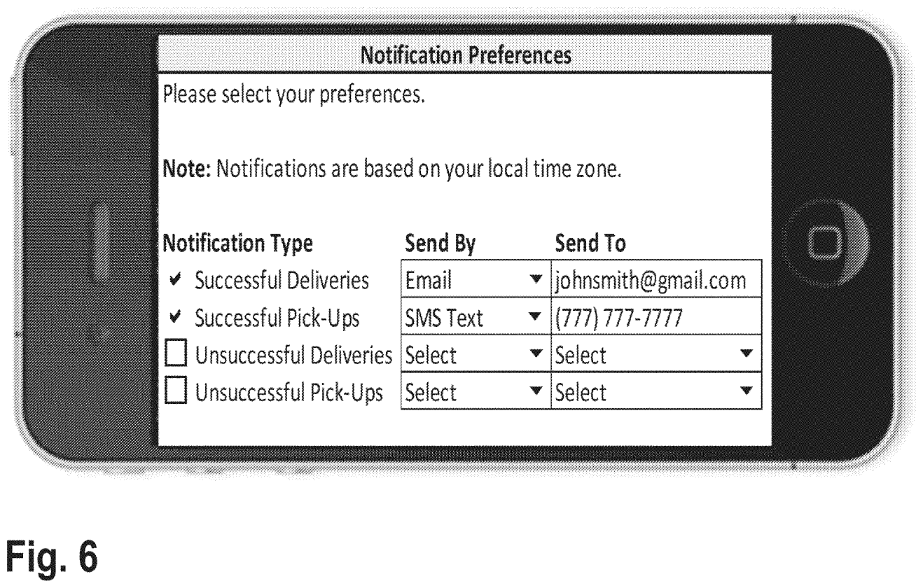

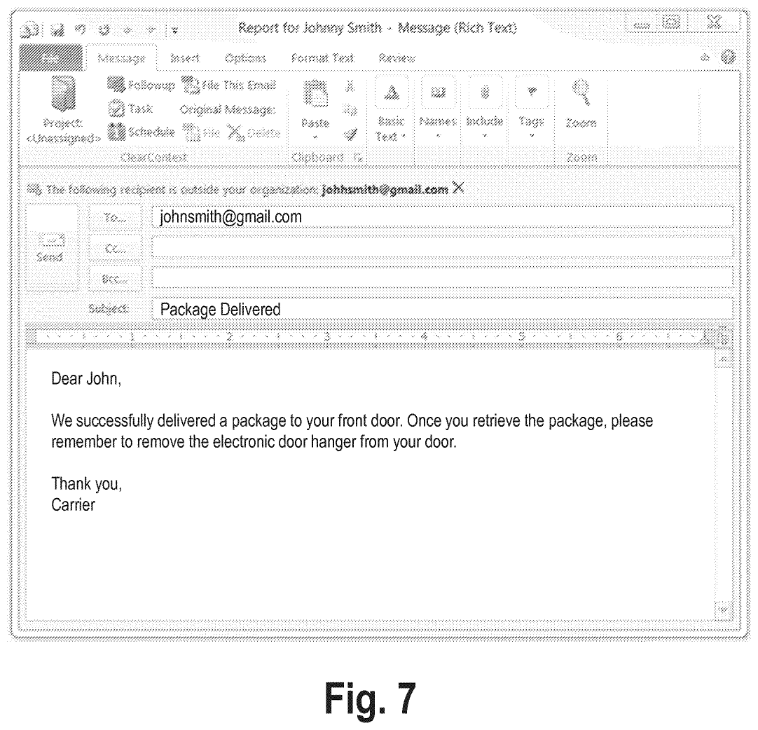

Reference will now be made to FIGS. 4A, 4B, 4C, 4D, 4E, 4F, 4G, and 5-8. FIGS. 4A, 4B, 4C, 4D, 4E, 4F, and 4G are electronic door hangers according to one embodiment of the present invention. FIGS. 5A and 5B are flowcharts illustrating operations and processes that can be used in accordance with various embodiments of the present invention. And FIGS. 6-8 are exemplary input and output produced with various embodiments of the present invention.

1. Registration

In one embodiment, as indicated in Block 500 of FIG. 5A, the process may begin with the enrollment/registration of one or more customers for an account, subscription, program, and/or similar words used herein interchangeably for notification/message services (e.g., as par to a pick-up and/or delivery program). As previously noted, a customer may be an individual, a family, a family member, a company, an organization, an entity, a department within an organization, a representative of an organization and/or person, and/or the like. To register, a customer (e.g., a customer or customer representative operating a customer computing entity 110) may access a webpage, application, dashboard, browser, or portal of an entity that provides notification/message services. As will be recognized, a variety of entities can provide notification/message services to adapt to various needs and circumstances.

In one embodiment, as part of the enrollment/registration process, a customer (e.g., a customer or customer representative operating a customer computing entity 110) may be requested to provide information/data (e.g., including customer information/data, biographic information/data, geographic information/data, device or entity information/data, payment information/data, and/or the like) by the carrier/transporter computing entity 100 (e.g., via the registration module). The information/data may be manually input by a customer; may be automatically provided by allowing access to other accounts, such as Amazon.com, Facebook, Gmail, Twitter, PayPal, and/or the like; may be automatically collected by various computing entities (including automatic device identification); combinations thereof; and/or other techniques and approaches. For instance, the biographic information/data may include the customer's name, such as a first name, a last name, a company name, an entity name, an organization name, and/or the like. The geographic information/data may also include one or more physical addresses associated with the customer (e.g., street address, city, state, postal code, and/or country). The physical addresses may be residential or commercial addresses, geocodes, latitude and longitude points, virtual addresses, and/or the like.

In one embodiment, the customer information/data may include one or more communication formats for communicating with the customer. The communication formats may include text messages (e.g., SMS, MMS), email messages, voice messages, video messages (e.g., YouTube, the Vine), picture messages (e.g., Instagram), social media messages (e.g., private social media created internally for entities, business social media (e.g., Yammer, SocialCast), or public social media (e.g., Facebook, Instagram, Twitter)), digital assistants message (e.g., Google Now, Ski), and/or a variety of other messages in various communication formats. In addition to the one or more communication formats, the customer (e.g., operating a customer computing entity 110) can provide the corresponding electronic destination addresses to be used in providing information/data associated with the notification/message services to the customer (e.g., email addresses, online handles, phone numbers, customer names, etc.). For instance, for text messages, the customer may provide one or more cellular phone numbers. For email messages, the customer may provide one or more email addresses. And for voice messages, the customer may provide one or more cellular or landline phone numbers or other electronic destination addresses to which audio files can be delivered. Additionally, in one embodiment, validation operations can be performed with respect to each input electronic destination address—to ensure accuracy. As will be recognized, a variety of other types of electronic destination addresses can be used to adapt to various needs and circumstances.

As will be recognized, the notification/message services may be provided as a free service or as a paid service or as part of another program. In certain embodiments, the customer (e.g., a customer or customer representative operating a customer computing entity 110) may be requested to provide payment information/data. Payments (e.g., the payment information/data) may be in a variety of forms, such as via debit cards, credit cards, direct credits, direct debits, cash, check, money order, Internet banking, e-commerce payment networks/systems (e.g., PayPal™ Google Wallet, Amazon Payments), virtual currencies (e.g., Bitcoins), award or reward points, and/or the like. Such payments may be made using a variety of techniques and approaches, including through NFC technologies such as PayPass, Android Beam, S Beam, BLE, and various other contactless payment systems. Further, such payment technologies may include PayPal Beacon, Booker, Erply, Leaf, Leapset, Micros, PayPal Here, Revel, ShopKeep, TouchBistro, Vend, and/or the like.

In one embodiment, device or entity information/data may also be received, provided, detected, assigned, collected, requested, and/or similar words used herein interchangeably as part of the registration/enrollment process. As will be recognized, device or entity information/data may be collected for any number of devices or entities for association with a customer's account, subscription, program, and/or similar words used herein interchangeably for notification/message services. The device or entity information/data may include one or more entity or device identifiers—phone numbers, Subscriber Identity Module (SIM) numbers, Media Access Control (MAC) addresses, International Mobile Subscriber Identity (IMSI) numbers, Internet Protocol (IP) addresses, Mobile Equipment Identifiers (MEIDs), unit identifiers (e.g., GPS unit identifiers, Unique Device Identifiers (UDiDs), mobile identification numbers (MINs), IMSI_S (Short IMSIs), email addresses, customer names, Globally Unique Identifiers (GUIDs), Integrated Circuit Card Identifiers (ICCIDs), electronic serial numbers (ESN), International Mobile Equipment Identities (IMEIs), Wi-Fi IDs, RFID tags, and/or the like. The device or entity information/data may include a device's vendor, model, specification authority, version, components, software specification and/or version, person associated with the device, and/or the like. The device or entity information/data may be used to track, monitor, connect with, communicate with, and/or the like the corresponding devices or entities. As will be recognized, a variety of other approaches and techniques can be used to adapt to various needs and circumstances.

In one embodiment, with the appropriate information/data, the carrier/transporter computing entity 100 may create a customer profile for the customer via the enrollment/registration process. Accordingly, the carrier/transporter computing entity 100 may create, store, and/or have access to various customer profiles and/or information/data associated with the customer profiles. In addition to at least the information/data described above, a customer profile may include one or more corresponding customer names, personal identification numbers (PINs), passwords, images, tokens, keys, passcodes, challenge phrases, reminders, and/or the like (referred to herein as credentials) for accessing accounts, applications, services, entities, notifications/messages, and/or the like.

In one embodiment, once a customer profile has been created by the carrier/transporter computing entity 100, the customer (e.g., operating a customer computing entity 110) can provide various preferences related to the notification/message services and/or have access to notification/message services (Block 505 of FIG. 5A). For instance, the customer (e.g., operating a customer computing entity 110) can provide a variety of preferences, including notification/message preferences regarding various events of interest. By way of example, the customer (e.g., a customer or customer representative operating a customer computing entity 110) may select, define, or otherwise configure the notifications/messages he or she wishes to receive based at least in part on events of interest. For example, as shown in FIG. 6, the customer (e.g., operating a customer computing entity 110) may select to receive notification/message services about successful or unsuccessful deliveries and/or pick-ups.

Although certain embodiments include using a registration-based approached, non-registration-based approaches are contemplated within the scope of the various embodiments and are also described herein. Thus, as will be recognized, embodiments of the present invention can be modified to adapt to a variety of needs and circumstances.

2. Notification/Message Services

In one embodiment, an appropriate computing entity (e.g., carrier/transporter computing entity 100, item 102, vehicle 107, electronic door hanger 115, user computing entity 120, and/or the like) can automatically provide (e.g., generate, queue, and/or transmit) one or more notifications/messages in compliance with users' notification/message preferences for events of interest (e.g., successful or unsuccessful deliveries and/or pick-ups and/or the like). Similarly, an appropriate computing entity (e.g., carrier/transporter computing entity 100, item 102, vehicle 107, electronic door hanger 115, user computing entity 120, and/or the like) can automatically provide the one or more notifications/messages to the electronic destination addresses in compliance with users' notification/message preferences. For example, an appropriate computing entity (e.g., carrier/transporter computing entity 100, item 102, vehicle 107, electronic door hanger 115, user computing entity 120, and/or the like) can generate, queue, and/or transmit an email message to a user's email address, a text message to a user's cellular phone, a notification/message to a designated application, and/or the like for various events of interest (e.g., successful or unsuccessful deliveries and/or pick-ups and/or the like) as defined in the user notification/message preferences.

In another embodiment, an appropriate computing entity (e.g., electronic door hanger 115, and/or the like) can broadcast information/data indicating that one or more notifications/messages are available to the customer (e.g., consignor, consignee) with the corresponding credentials (e.g., customer names, PINs) passwords, keys, passcodes, images, tokens, challenge phrases, reminders, and/or the like). For instance, if a customer is not registered, an electronic door hanger 115 can broadcast information/data regarding the pick-up or delivery.

To receive such notification/message services, one or more customer computing entities 110 may be fixed or mobile with regard to their geographic locations. In one embodiment, customer computing entities 110 may be fixed with regard to their geographic locations (e.g., desktop computers, televisions, routers, and/or the like), such as by being in fixed positions at residential or commercial locations. Similarly, customer computing entities 110 may be mobile (e.g., smartphones, watches, and/or the like) with regard to their geographic locations. As will be recognized, electronic door hangers 115 may also be mobile with regard to their geographic locations by being carried to and placed on doors, for instance, at customer locations. As will be recognized, a variety of other approaches and techniques can be used to adapt to various needs and circumstances.

a. Item/Shipment Information/Data for Pick-Up and/or Delivery

In one embodiment, when an item/shipment 102 is to be picked up and/or delivered by the carrier/transporter using the carrier's transportation and logistics network, the item/shipment 102 may be associated with item/shipment information/data. The item/shipment information/data may comprise or be associated with input information/data, intermediate information/data, pick-up information/data, delivery information/data, exception information/data, tracking information/data, item-level information/data, consignor information/data, consignee information/data, name information/data, address information/data, billing information/data, and/or similar words used herein interchangeably.

In one embodiment, this information/data may comprise details about the item/shipment 102 itself, such as the length, width, base, radius, height, cube/volume (e.g., cubic feet, cubic centimeters, etc.), and/or weight (e.g., pounds, grams, etc.). The information/data may also include information/data about the type of or contents of the item/shipment 102, such as being of a special handling category. Such information/data may be obtained from a scan or other inspection of the item/shipment 102, including the scanning of a unique item/shipment identifier on the item/shipment 102 which refers to additional information/data about the item/shipment 102. Similarly, the information/data may be captured when the item/shipment 102 is first received by the carrier/transporter (e.g., receiving an item for ingestion into the transportation and logistics network), from a user generating a label or unique identifier, automatic detection using various systems, manually input information/data, and/or the like.

In one embodiment, the information/data may comprise details about the service level. Exemplary services levels may include Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like. As will be recognized, various other services levels are contemplated within embodiments of the present invention.

In one embodiment, the information/data may include address information/data, consignor information/data, consignee information/data, and/or name information/data. The address information/data may comprise the address of the consignor and/or consignee that can be parsed by an appropriate computing entity (e.g., carrier/transporter computing entity 100, customer computing entity 110, payment computing entity 115, external information/data source computing entity 120, and/or the like). The consignee information/data, consignor information/data, and/or name information/data for a person may include a title, a given name, a surname, a suffix, a nickname, and/or the like. The consignee information/data, consignor information/data, and/or name information/data for an entity may include an entity name, entity designation, and/or the like. As will be recognized, a variety of other approaches and techniques can be used to adapt to various needs and circumstances.

As previously indicated, the information/data may also include tracking information/data (of various “tracking events”) corresponding to the location of the item/shipment 102 in the transportation and logistics network as indicated by the tracking events, including one or more origin entity and destination entity pairs. To reflect the item's movement, an item/shipment identifier associated with the item/shipment 102 may, for example, be scanned or otherwise electronically read at various points as the item/shipment 102 is transported through the carrier's transportation and logistics network (include successful or unsuccessful pick-ups or deliveries). As indicated, these events may be referred to as tracking events. For the tracking events, an item/shipment identifier may be automatically scanned by a barcode or MaxiCode device, an RFID interrogator, a camera controller, a carrier/transporter employee using a customer computing entity 110, and/or the like. In one embodiment, each time an item/shipment identifier is scanned or read, an appropriate device/entity can generate information/data associated with the tracking event and transmit the appropriate information/data (e.g., item/shipment identifier, location and time of the scan or reading, event type, bundle/container, and/or the like) to the carrier/transporter computing entity 100 for storage in the item/shipment database. That is, during the item's transit from an origin to a delivery location, intermediate information/data and other information/data from tracking events may be obtained at various waypoints for storage.

In one embodiment, the tracking information/data may include exception information/data and/or delivery information/data. For instance, if there is a problem or exception to the normal handling procedures for an item/shipment 102, exception information/data may be obtained and stored. Exception information/data may indicate when and why a particular item/shipment 102 was not deliverable (e.g., incorrect primary address information/data, missing secondary information/data, consignee/consignor moved, and/or the like). Delivery information/data may include information/data obtained about an item/shipment 102 when it is delivered to the consignee, locker, delivery location, and/or the like. For example, a delivery scan may be accomplished by the person or driver (e.g., carrier/transporter personnel/operator) making the delivery via a customer computing entity 110 to record delivery information/data, such as the date, time, location, consignee identity, consignee signature, delivery location, and other information/data related to the delivery. As will be recognized, a variety of other approaches and techniques can be used to adapt to various needs and circumstances.

b. Pick-Ups and/or Deliveries

In one embodiment, carrier/transporter personnel/operator for the carrier/transporter can visit customer locations (e.g., consignor locations and/or consignee locations) to pick-up and/or deliver items/shipments that will be or have been transported through the carrier's transportation and logistics network. For instance, upon arriving at a pick-up location for an item/shipment 102, carrier/transporter personnel/operator can access or input item/shipment information/data for an item/shipment 102. Similarly, upon arriving at a delivery location for an item/shipment 102 to a consignee, carrier/transporter personnel/operator can access item/shipment information/data for the item/shipment 102 that includes the consignee's name and delivery location via a user computing entity 120. The corresponding item/shipment information/data can be displayed by the user computing entity 120 for viewing by carrier/transporter personnel/operator.

In the event an item/shipment 102 is successfully picked up or delivered based on the provided item/shipment information/data, carrier/transporter personnel/operator can input a corresponding entry (e.g., via a customer computing entity 110) indicating when, where, and/or from or to whom the item/shipment 102 was picked up or delivered—which can then be provided by carrier/transporter personnel/operator (e.g., operating user computing entities 120) to a variety of computing entities for storage as item/shipment information/data. Then, an appropriate computing (e.g., carrier/transporter computing entity 100 or a user computing entity 120 operated by carrier/transporter personnel/operator) can provide item/shipment information/data to an electronic door hanger 115 using any of a variety of communication protocols at the pick-up or delivery location. Thus, the item/shipment information/data provided and received by the electronic door hanger 115 may include the what, when, where, and/or from or to whom the item/shipment 102 was picked up or delivered. The electronic door hanger 115 may also be provided and receive information/data associated with the corresponding customer's profiles, such as device or entity information/data and/or credentials that may allow registered customers to access the information/data stored by the electronic door hanger 115. With such information/data, carrier/transporter personnel/operator can leave the electronic door hanger 115 at the pick-up or delivery location to be discovered locally or remotely by one or more customer computing entities 110 (Block 510 of FIG. 5A). The electronic door hanger 115 can communicate/transmit and/or display (e.g., via the display area/portion) the item/shipment information/data.

Similarly, in the event an item/shipment 102 is not successfully picked up or delivered, carrier/transporter personnel/operator can input a corresponding entry (e.g., via a customer computing entity 110) indicating when, where, and/or why the item/shipment 102 was not successfully picked up or delivered (e.g., not home for signature, weather conditions, and/or the like)—which can then be provided by carrier/transporter personnel/operator (e.g., operating user computing entities 120) to a variety of computing entities for storage as item/shipment information/data. Then, an appropriate computing (e.g., carrier/transporter computing entity 100 or a user computing entity 120 operated by carrier/transporter personnel/operator) can provide item/shipment information/data to an electronic door hanger 115 using any of a variety of communication protocols. As will be recognized, the item/shipment information/data may include information/data indicating when, where, and/or why the item/shipment 102 was not successfully picked up or delivered. The item/shipment information/data may include information/data providing instructions, locations, contact information, and/or the like to assist in successfully completing pick-up or delivery of an item/shipment 102. The electronic door hanger 115 may also be provided and receive information/data associated with the corresponding customer's profiles, such as device or entity information/data and/or credentials that may allow registered customers to access the information/data stored by the electronic door hanger 115. With such information/data, carrier/transporter personnel/operator can then leave the electronic door hanger 115 at or proximate the unsuccessful pick-up or delivery location to be discovered locally or remotely by one or more customer computing entities 110 (Block 510 of FIG. 5A). The electronic door hanger 115 can communicate/transmit and/or display (e.g., via the display area/portion) the item/shipment information/data.

In certain embodiments, electronic door hangers 115 can be placed at future pick-up and delivery locations as a “pre-alert” that an item/shipment 102 is scheduled to be picked up or delivered in the near futures (e.g., hours, days, and/or the like). This can allow the consignor or consignee to act and arrange ensure that he or she is available for the pick-up or delivery and/or make alternate arrangements as described in U.S. application Ser. No. 14/025,893, which is hereby incorporated in its entirety by reference.

3. Enrollment/Registration Based Notifications/Messages

a. Connection and Enrollment/Registration Based Notifications/Messages

In one embodiment, an appropriate computing entity (e.g., carrier/transporter computing entity 100, item 102, vehicle 107, electronic door hanger 115, user computing entity 120, and/or the like) can automatically connect with and communicate item/shipment information/data to customer computing entities 110 for customers registered for notification/message services once an electronic door hanger 115 is placed proximate a pick-up or delivery location (Block 525 of FIG. 5A). In certain embodiments this may also require that an appropriate computing entity (e.g., carrier/transporter computing entity 100, item 102, vehicle 107, electronic door hanger 115, user computing entity 120, and/or the like) be within a range, geofence, zone of confidence, tolerance, and/or the like of the residential or commercial addresses associated with the customer based at least in part on, for example, geocodes, latitude and longitude points, and/or the like associated with the same.

In these embodiments, it will be recognized that certain communication technologies and protocols have range limitations for directly connecting to and/or directly communicating with computing entities (e.g., RFID, point-to-point, peer-to-peer, WLAN, WPAN, and/or the like). For example, various NFC technologies may have range limitations of less than 12-36 inches. Bluetooth technologies may have range limitations from 20 feet to 300 feet. Wi-Fi Direct may have range limitations of 600 feet. LTE and Wi-Max, for example, may have range limitations of 1-30 miles. Thus, depending on the application or context of the notifications/messages desired, various communication technologies and protocols can be used to adapt to various needs and circumstances. For instance, Bluetooth or Wi-Fi Direct technologies may be used for electronic door hangers 115 to connect or communicate with customer computing entities 110 in relatively close proximity (e.g., electronic door hangers 115 placed on a front door that will connect to customer computing entities 110 with the specified range). Similarly, LTE, Wi-Max, and/or other technologies may be used for electronic door hangers 115 to directly or indirectly (e.g., via one or more networks) connect or communicate with customer computing entities 110 and/or carrier/transporter computing entities 100 in remote locations. As will be recognized, a variety of other approaches and techniques can be used to adapt to various needs and circumstances.

In one embodiment, to create a connection between a customer computing entity 110 and an electronic door hanger 115, a trusted relationship can be established between the entities/devices and/or credentials exchanged that can be stored by each device. In the Bluetooth context, establishing a connection with the appropriate credentials available may begin with a phase called “inquiry” through which either an electronic door hanger 115 or a customer computing entity 110 sends an inquiry requesting a response from all capable entities found within its range. The electronic door hangers 115 or customer computing entities 110 within range would then receive the query and reply. The appropriate customer computing entity 110 (with the appropriate credentials) and the electronic door hanger 115 can then establish a connection. As will be recognized, other communication technologies and protocols (e.g., NFC, Wibree, HomeRF, SWAP, Wi-Fi Direct, and/or the like) can be used in a similar manner in terms of connecting and disconnecting with electronic door hangers 115. That is, the other communication technologies and protocols can establish connections between customer computing entities 110 and electronic door hangers 115. In one embodiment, the electronic door hangers 115 or customer computing entities 110 may attempt to establish such connections using the appropriate credentials regularly, periodically, continuously, during certain time periods or time frames, on certain days, upon determining the occurrence of one or more predefined triggers/events, combinations thereof, and/or the like.

In one embodiment, once the computing entities (e.g., carrier/transporter computing entity 100, item 102, vehicle 107, electronic door hanger 115, user computing entity 120, and/or the like) establish a connection or communication, an appropriate computing entity (e.g., carrier/transporter computing entity 100, item 102, vehicle 107, electronic door hanger 115, user computing entity 120, and/or the like) can provide notifications/messages to the customer computing entity 110 regarding successful pick-ups and/or deliveries and/or unsuccessful pick-ups and/or deliveries (Block 530 of FIG. 5A). In certain embodiments, this allows the carrier/transporter personnel/operator being physically present at the delivery point to deliver information/data to the customer. Continuing with the above example, an appropriate computing entity (e.g., carrier/transporter computing entity 100, item 102, vehicle 107, electronic door hanger 115, user computing entity 120, and/or the like) may determine/identify when a customer computing entity 110 and an electronic door hanger 115 registered for notification/message services are connected (e.g., communicating with one another). For instance, assume John Smith has registered for notifications/messages for a pick-up and/or delivery program, and his smartphone and an electronic door hanger 115 on his front door establish a connection with one another (e.g., the entities automatically connect via Bluetooth, Wi-Fi Direct, NFC). Once a connection is established between the entities/devices, an appropriate computing entity (e.g., carrier/transporter computing entity 100, item 102, vehicle 107, electronic door hanger 115, user computing entity 120, and/or the like) can provide one or more notifications/messages in accordance with Mr. Smith's notification/message preferences. For instance, the notifications/messages can be provided by the electronic door hanger 115 and/or the carrier/transporter computing entity 100 using Mr. Smith's notification/message preferences. The same or similar notifications/messages can be displayed through the display area/portion 412 of the electronic door hanger 115 as well. The display area/portion can also display advertisements, invoices, coupons, incentives, and/or the like.

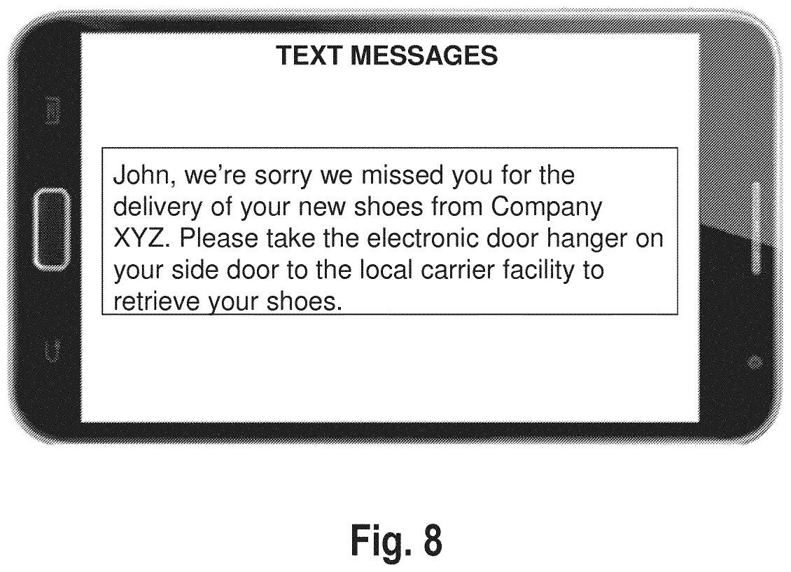

In terms of the notification/message preferences, FIG. 6 shows illustrative notification/message preferences. In these examples, the notification/message preferences include emails for successful deliveries and text messages for successful pick-ups regarding the same. As will be recognized, notifications/messages can be provided for unsuccessful pick-ups and/or deliveries. FIG. 7 shows an embodiment in which an email message is provided by an appropriate computing entity (e.g., carrier/transporter computing entity 100, item 102, vehicle 107, electronic door hanger 115, user computing entity 120, and/or the like) regarding a successful delivery instructing the customer to retrieve his package and the electronic door hanger 115. The notification/message indicates that a package was delivered and that the customer can pick up the package and the electronic door hanger 115 at his front door. FIG. 8 shows an embodiment in which a text message is provided by an appropriate computing entity (e.g., carrier/transporter computing entity 100, item 102, vehicle 107, electronic door hanger 115, user computing entity 120, and/or the like) regarding an unsuccessful delivery. In particular, the text messages indicates that the delivery of the shoes from Company XYZ was unsuccessful, but can be completed by taking the electronic door hanger 115 to the local carrier/transporter facility to retrieve the shoes.

In one embodiment, an electronic door hanger 115 can be used by the carrier/transporter as a “claim ticket” that can be read or scanned to provide the corresponding item/shipment 102 to the customer at a carrier/transporter facility. Such carrier/transporter facilities can be staffed facilities (will call) or unstaffed facilities (e.g., lockers and/or the like). Picking up the corresponding item/shipment 102 may require providing a form of government identification or other acceptable form of identification along with any specified credentials. As will be recognized, a variety of other approaches and techniques can be used to adapt to various needs and circumstances.

b. Proximity and Enrollment/Registration Based Notifications/Messages

In one embodiment, an appropriate computing entity (e.g., carrier/transporter computing entity 100, item 102, vehicle 107, electronic door hanger 115, user computing entity 120, and/or the like) can monitor the location of customer computing entities 110 and automatically communicate item/shipment information/data to customer computing entities 110 for customers registered for notification/message services once an electronic door hanger 115 is placed proximate a pick-up or delivery location. To do so, an appropriate computing entity (e.g., carrier/transporter computing entity 100, item 102, vehicle 107, electronic door hanger 115, user computing entity 120, and/or the like) may monitor the location of one or more corresponding customer computing entities 110 regularly, periodically, continuously, during certain time periods or time frames, on certain days, upon determining the occurrence of one or more predefined triggers/events, combinations thereof, and/or the like (Block 515 of FIG. 5A). The one or more predefined triggers/events may include the electronic door hanger 115 (a) being turned on or off; (b) being activated; (c) being placed on a door; (d) being moved out of a geo-fenced area; (e) being moved into a geo-fenced area; and/or a variety of other triggers/events. As will be recognized, a variety of other triggers/events can be used to adapt to various needs and circumstances.

Generally, the locations of one or more electronic door hangers 115 and/or one or more customer computing entities 120 can be monitored by any of a variety of computing entities—carrier/transporter computing entities 100, electronic door hangers 115, user computing entities 120, and/or the like. For example, the locations of one or more of the electronic door hangers 115 and/or one or more customer computing entities 120 may be monitored with the aid of or in coordination with location-determining devices, location-determining aspects, location-determining features, location-determining functionality, location-determining sensors, and/or other location services. Such may include GPS; cellular-assisted GPS; real time location systems or server technologies using received signal strength indicators from a Wi-Fi network); triangulating positions in connection with a variety of other systems, including cellular towers, Wi-Fi access points, and/or the like; and/or the like. By using the locations of one or more of the electronic door hangers 115 and/or one or more customer computing entities 120, an appropriate computing entity (e.g., carrier/transporter computing entity 100, item 102, vehicle 107, electronic door hanger 115, user computing entity 120, and/or the like) can determine, for example, when an electronic door hanger 115 and/or a customer computing entity 120 are within a configurable distance from one another.

In one embodiment, a configurable distance may be a distance, range, zone of confidence, geofence, tolerance, and/or similar words used herein interchangeably. For example, in one embodiment, the configurable distance may be plus or minus (±) a specific distance or range using a coordinate system (e.g., DD, DMS, UTM, and/or UPS). As will be recognized, a configurable distance may be in a variety of formats, such as degrees, minutes, seconds, feet, meters, miles (e.g., 3, 15, 30, or 50 feet), kilometers, and/or the like. Continuing with the above example, an appropriate computing entity (e.g., carrier/transporter computing entity 100, item 102, vehicle 107, electronic door hanger 115, user computing entity 120, and/or the like) may use a configurable distance of ±0.000001, ±0.000001 in the DD coordinate system (or configurable distances of ±0.000100, ±0.000100 or ±0.000010, ±0.000010) to determine/identify when an electronic door hanger 115 and/or a customer computing entity 120 registered for notification/message services are within a configurable distance of each other. For instance, assume an electronic door hanger is placed on a front door located at 33.7869128, −84.3875602, and a customer computing entity 110 for John Smith (John Smith's phone) is located at 33.7869129, −84.3875601 when he pulls into his driveway. At that point, the two entities would be within the configurable distance of ±0.000001, ±0.000001. An appropriate computing entity (e.g., carrier/transporter computing entity 100, item 102, vehicle 107, electronic door hanger 115, user computing entity 120, and/or the like) monitoring the entities can make this determination/identification.

In the event the two entities are within a configurable distance from each other (e.g., associated with one another), an appropriate computing entity (e.g., carrier/transporter computing entity 100, item 102, vehicle 107, electronic door hanger 115, user computing entity 120, and/or the like) can provide notifications/message regarding successful pick-ups and/or deliveries and/or unsuccessful pick-ups and/or deliveries and/or establish a connection with the corresponding customer computing entity 110 (as previously described)—Block 520 of FIG. 5A. For instance, an appropriate computing entity (e.g., carrier/transporter computing entity 100, item 102, vehicle 107, electronic door hanger 115, user computing entity 120, and/or the like) can provide one or more notifications/messages in accordance with Mr. Smith's notification/message preferences. For instance, the notifications/messages can be provided by the electronic door hanger 115 and/or the carrier/transporter computing entity 100 using Mr. Smith's notification/message preferences. The same or similar notifications/messages can be displayed through the display area/portion 412 of the electronic door hanger 115 as well. The display area/portion can also display advertisements, invoices, coupons, incentives, and/or the like.

As previously described, notifications/messages can be provided for successful pick-ups and/or deliveries and/or unsuccessful pick-ups and/or deliveries. FIG. 7 shows an embodiment in which an email message is provided by an appropriate computing entity (e.g., carrier/transporter computing entity 100, item 102, vehicle 107, electronic door hanger 115, user computing entity 120, and/or the like) regarding a successful delivery instructing the customer to retrieve his package and the electronic door hanger 115. The notification/message indicates that a package was delivered and that the customer can pick up the package and the electronic door hanger 115 at his front door. FIG. 8 shows an embodiment in which a text message is provided by an appropriate computing entity (e.g., carrier/transporter computing entity 100, item 102, vehicle 107, electronic door hanger 115, user computing entity 120, and/or the like) regarding an unsuccessful delivery. In particular, the text messages indicates that the delivery of the shoes from Company XYZ was unsuccessful, but can be completed by taking the electronic door hanger 115 to the local carrier/transporter facility to retrieve the shoes. Further, the electronic door hanger 115 can be used by the carrier/transporter as a “claim ticket” that can be read or scanned to provide the corresponding item/shipment 102 to the customer at the carrier/transporter facility. Picking up the corresponding item/shipment 102 may require providing a form of government identification or other acceptable form of identification along with any specified credentials. As will be recognized, a variety of other approaches and techniques can be used to adapt to various needs and circumstances.

4. Non-Enrollment/Registration Based Notifications/Messages

In one embodiment, an appropriate computing entity (e.g., carrier/transporter computing entity 100, item 102, vehicle 107, electronic door hanger 115, user computing entity 120, and/or the like) can automatically connect with and/or automatically communicate item/shipment information/data to customer computing entities 110 and/or their associated networks (both terms used herein interchangeably) for customers who are not registered/enrolled as described in previous embodiments. This may be advantageous when a carrier/transporter desires to communicate information/data but does not have knowledge beforehand of a customer's electronic destination addresses and/or the like. In certain embodiments this may also require that an appropriate computing entity (e.g., carrier/transporter computing entity 100, item 102, vehicle 107, electronic door hanger 115, user computing entity 120, and/or the like) be within a range, geofence, zone of confidence, tolerance, and/or the like of the residential or commercial addresses associated with the customer based at least in part on, for example, geocodes, latitude and longitude points, and/or the like associated with the same.

a. Open and Non-Registration Based Notifications/Messages

In one embodiment, to do so, once an electronic door hanger 115 has been placed at a pick-up or delivery location, the electronic door hanger 115 can automatically connect to one or more open customer computing entities 110 and/or open associated networks (Blocks 535, 540 of FIG. 5B) within range. In other embodiments, various other computing entities (e.g., carrier/transporter computing entity 100, item 102, vehicle 107, user computing entity 120, and/or the like) can be used in place or in addition to the electronic door hanger 115 as described below. The term open refers to a network or connection that can be joined by anyone (e.g., no credentials are required). For instance, customer computing entities 110 and/or their associated networks (both terms used herein interchangeably) can broadcast identifying information/data (e.g., entity or network name, user friendly name, ID, and/or the like) using a variety of techniques and approaches. For example, the customer computing entities 110 and/or their associated networks can broadcast this information/data using basic service sets (BSSs), extended service sets (ESSs), service set identifiers (SSIDs), Bluetooth inquiry states, and/or a variety of other protocols and techniques. In certain embodiments, in addition to broadcasting identifying information/data (e.g., entity or network name, user friendly name, ID, and/or the like), the customer computing entities 110 and/or their associated networks (both terms used herein interchangeably) can provide the passcode, keys, and/or other credentials necessary for establishing communication to any devices/entities within range. Thus, the devices/entities and networks are open. In one embodiment, each residential or commercial location may have a dedicated customer computing entity 110 and network available for service providers to connect to and provide information/data to the corresponding customers (e.g., to indicate a visit, service, or repair was attempted or made). In these examples, the identifying information/data may comprise the address associated with the residential or commercial location.

In certain embodiments, the electronic door hanger 115 can automatically connect to a customer computing entity 110 and/or an associated network provided that credentials are not required or were received for the same. In other embodiments, various other computing entities can connect to and communicate with the customer computing entity 110. For instance, an open customer computing entity 110 and/or associated network can broadcast its identifying information/data (e.g., entity or network name or ID) and/or credentials using a variety of techniques and approaches. Or the customer computing entity 110 and/or associated network may not require any credentials. The electronic door hanger 115 can then automatically connect to and communicate item/shipment information/data to any open customer computing entities 110 and/or networks within range and with which it is connected. Thus, the electronic door hanger 115 may connect to and communicate with a plurality of customer computing entities 110 and/or networks within its range. For instance, for the open customer computing entities 110 and/or networks, certain communication technologies and protocols (e.g., Wi-Fi Direct, Bluetooth, Wi-Max, LTE, RFID, point-to-point, peer-to-peer, WLAN, WPAN, and/or the like) have range limitations for directly connecting to and/or directly communicating with computing entities via the same. As will be recognized, a variety of other approaches and techniques can be used to adapt to various needs and circumstances.

In one embodiment, once the computing entities (e.g., carrier/transporter computing entity 100, item 102, vehicle 107, electronic door hanger 115, user computing entity 120, and/or the like) establish a connection or communication, an appropriate computing entity (e.g., carrier/transporter computing entity 100, item 102, vehicle 107, electronic door hanger 115, user computing entity 120, and/or the like) can provide notifications/messages to any connected customer computing entities 110 and/or networks regarding successful pick-ups and/or deliveries and/or unsuccessful pick-ups and/or deliveries (Block 545 of FIG. 5B). In certain embodiments, this allows the carrier/transporter personnel/operator being physically present at the delivery point to deliver information/data to the customer. To do so, an appropriate computing entity (e.g., carrier/transporter computing entity 100, item 102, vehicle 107, electronic door hanger 115, user computing entity 120, and/or the like) may first receive an indication that a connection was established and information/data identifying the customer or item/shipment 102. Continuing with the above example, an appropriate computing entity (e.g., carrier/transporter computing entity 100, item 102, vehicle 107, electronic door hanger 115, user computing entity 120, and/or the like) may provide such notifications/messages to all connected customer computing entities 110 and/or networks. For instance, assume John Doe has not registered for notifications/messages for a pick-up and/or delivery program, but his home router, computer, or smartphone (e.g., open customer computing entities 110 and/or networks) and an electronic door hanger 115 on his front door establish a connection with one another (e.g., the entities automatically connect via open Bluetooth, Wi-Fi Direct). Once a connection is established between the entities/devices, an appropriate computing entity (e.g., carrier/transporter computing entity 100, item 102, vehicle 107, electronic door hanger 115, user computing entity 120, and/or the like) can provide one or more notifications/messages regarding attempted (e.g., successful/unsuccessful) pick-ups and/or deliveries. The notifications/messages can be provided by the electronic door hanger 115 and/or the carrier/transporter computing entity 100 to Mr. Doe's customer computing entities 110 and/or networks. The same or similar notifications/messages can be displayed through the display area/portion 412 of the electronic door hanger 115 as well. The display area/portion can also display advertisements, invoices, coupons, incentives, and/or the like. In certain embodiments, only such information/data is provided to the customer computing entity 110 and/or associated network without the electronic door hanger 115 being left or placed at the customer location.

In one embodiment, notifications/messages may include emails, text messages, application-based messages, and/or other types of notifications/messages based on the capabilities of the connected customer computing entities 110 and/or networks. As will be recognized, notifications/messages can be provided for unsuccessful pick-ups and/or deliveries. The notifications/messages can provide information/data about successful pick-ups and/or deliveries and/or unsuccessful pick-ups and/or deliveries. In one embodiment, an electronic door hanger 115 can be used by the carrier/transporter as a “claim ticket” that can be read or scanned to provide the corresponding item/shipment 102 to the customer at a carrier/transporter facility. Such carrier/transporter facilities can be staffed facilities (will call) or unstaffed facilities (e.g., lockers and/or the like). Picking up the corresponding item/shipment 102 may require providing a form of government identification or other acceptable form of identification along with any specified credentials. As will be recognized, a variety of other approaches and techniques can be used to adapt to various needs and circumstances.

b. Closed and Non-Registration Based Notifications/Messages

In one embodiment, once an electronic door hanger 115 has been placed at a pick-up or delivery location, the electronic door hanger 115 can automatically connect to one or more closed customer computing entities 110 and/or closed associated networks (Blocks 535, 540 of FIG. 5B) within range. The term closed refers to a network or connection that required credentials to join. In one embodiment, each residential or commercial location may have a dedicated customer computing entity 110 and network available for service providers to connect to and provide information/data to the corresponding customers (e.g., to indicate a visit, service, or repair was attempted or made). In these examples, the identifying information/data may comprise the address associated with the residential or commercial location.

In one embodiment, certain implementations presume the ability to activate or push a “connection” button (e.g., an actual “connection” button or virtual/soft “connection” button) for a customer computing entity 110 and/or associated network. The actual/physical “connection” button or virtual/soft “connection” button can be used to temporarily open a closed computing entity or network to computing entities/devices for a configurable period of time. Such technologies include Push 'N Connect, Push Button Connect, Push-Button-Connect, and/or similar and/or related technologies. Thus, the actual/physical “connection” button or virtual/soft “connection” button may be a doorbell, a placard, a soft interface, a physical button/key, a virtual/soft button/key, and/or the like. In these examples, a connection button can be pushed or activated on a customer computing entity 110 and/or associated network—including by use of biometrics, facial recognition, and/or the like. For instance, a placard (e.g., comprising a barcode) or doorbell can be positioned at a residence or commercial location that activates a customer computing entity 110 and/or associated network to allow for entities (e.g., an electronic door hanger 115 and/or other devices and entities) to automatically connect to the same for a configurable period of time (e.g., 30 seconds, 2 minutes, and/or the like). During this configurable period of time, the customer computing entity 110 and/or associated network can allow connections from any entities/devices within range (e.g., carrier/transporter computing entities 100, items 102, vehicles 107, electronic door hangers 115, user computing entities 120, and/or the like)—including providing any necessary credentials to the connecting devices/entities.

In one embodiment, once the computing entities (e.g., carrier/transporter computing entity 100, item 102, vehicle 107, electronic door hanger 115, user computing entity 120, and/or the like) establish a connection or communication, an appropriate computing entity (e.g., carrier/transporter computing entity 100, item 102, vehicle 107, electronic door hanger 115, user computing entity 120, and/or the like) can provide notifications/messages to any connected customer computing entities 110 and/or networks regarding successful pick-ups and/or deliveries and/or unsuccessful pick-ups and/or deliveries (Block 545 of FIG. 5B). In certain embodiments, this allows the carrier/transporter personnel/operator being physically present at the delivery point to deliver information/data to the customer. To do so, an appropriate computing entity (e.g., carrier/transporter computing entity 100, item 102, vehicle 107, electronic door hanger 115, user computing entity 120, and/or the like) may first receive an indication that a connection was established and information/data identifying the customer or item/shipment 102. Continuing with the above example, an appropriate computing entity (e.g., carrier/transporter computing entity 100, item 102, vehicle 107, electronic door hanger 115, user computing entity 120, and/or the like) may provide such notifications/messages to all connected customer computing entities 110 and/or networks. For instance, assume John Doe has not registered for notifications/messages for a pick-up and/or delivery program, but his home router, computer, or smartphone (e.g., open customer computing entities 110 and/or networks) and an electronic door hanger 115 on his front door establish a connection with one another (e.g., the entities automatically connect via Bluetooth, Wi-Fi Direct). Once a connection is established between the entities/devices, an appropriate computing entity (e.g., carrier/transporter computing entity 100, item 102, vehicle 107, electronic door hanger 115, user computing entity 120, and/or the like) can provide one or more notifications/messages regarding attempted (e.g., successful/unsuccessful) pick-ups and/or deliveries. The notifications/messages can be provided by the electronic door hanger 115 and/or the carrier/transporter computing entity 100 to Mr. Doe's customer computing entities 110 and/or networks. The same or similar notifications/messages can be displayed through the display area/portion 412 of the electronic door hanger 115 as well. The display area/portion can also display advertisements, invoices, coupons, incentives, and/or the like. In certain embodiments, only such information/data is provided to the customer computing entity 110 and/or associated network without the electronic door hanger 115 being left or placed at the customer location.

In one embodiment, notifications/messages may include emails, text messages, application-based messages, and/or other types of notifications/messages based on the capabilities of the connected customer computing entities 110 and/or networks. As will be recognized, notifications/messages can be provided for unsuccessful pick-ups and/or deliveries. The notifications/messages can provide information/data about successful pick-ups and/or deliveries and/or unsuccessful pick-ups and/or deliveries. In one embodiment, an electronic door hanger 115 can be used by the carrier/transporter as a “claim ticket” that can be read or scanned to provide the corresponding item/shipment 102 to the customer at a carrier/transporter facility. Such carrier/transporter facilities can be staffed facilities (will call) or unstaffed facilities (e.g., lockers and/or the like). Picking up the corresponding item/shipment 102 may require providing a form of government identification or other acceptable form of identification along with any specified credentials. As will be recognized, a variety of other approaches and techniques can be used to adapt to various needs and circumstances.

### IV. Additional Exemplary System Operations

The following description of additional or alternative embodiments may be used alone or in conjunction with one or more of the features, devices, components, systems, methods, and/or computer-readable media previously described herein. As such, the systems, methods, computer-readable media, and/or devices discussed hereinafter are not limited in this regard. However, it will be understood from this description that the systems, methods, computer-readable media, and/or devices discussed hereinafter should not be construed as limited to any dependence upon the one or more of the features, devices, components, systems, methods, and/or computer-readable media previously described unless otherwise expressly specified.

As discussed hereinabove, some embodiments automatically provide a notification regarding a pick-up or a delivery of an item to an electronic destination address associated with the customer's notification preferences, in response to determining that the electronic door hanger and the customer computing entity are within the configurable distance from each other. Additionally or alternatively, subsequent to delivery of a package, embodiments automatically provide a notification regarding an unauthorized removal, such as a theft of the package or act of “porch piracy,” in response to determining that the package and the customer computing entity are no longer within the configurable distance of each other, or another reference location. For example, systems, methods, and computer-readable media may monitor a location of a package having a carrier transmitter device (e.g., an RFID tag), a location of a customer computing entity, or both. In some embodiments, a customer associated with the customer computing entity may also be registered for notification services for the package or other packages. At or near in time to the package having the carrier transmitter being physically placed at a pick-up or delivery location, the systems, methods, and computer-readable media herein are able to determine that the package having the carrier transmitter device and the customer computing entity are within a configurable distance from each other. The systems, methods, and computer-readable media discussed herein may continue to monitor the location of the package having the carrier transmitter device in relation to the location of the customer computing entity and/or delivery address geo-location. Further, in response to a subsequent determination that the package having the carrier transmitter device and the customer computing entity are no longer within the configurable distance from each other, the systems, methods, and computer-readable media herein automatically provide a notification regarding an unauthorized removal of the package, such as a theft or act of “porch piracy” to an appropriate entity.

In another example, at or near in time to the package having the carrier transmitter being physically placed at a pick-up or delivery location, a carrier computing entity (e.g., a mobile device associated with a delivery vehicle and/or delivery personnel) connects to a wireless network at the pick-up or delivery location. The carrier computing entity may be authorized to connect to the wireless network at the pick-up or delivery location through an electronic interrogation and authorization, for example, performed with the customer computing entity and/or an application. Once connected and/or authorized, the carrier computing entity may transmit information regarding the package and the carrier transmitter device over the wireless network to an application. For example, information such as an image of a package located at the delivery location could be captured by a camera of the carrier computing entity and wirelessly transmitted to an application. In one such example, the information may act as a proof of delivery of the package. Additionally or alternatively, the information may include a package identifier, a shipping record identifier, a customer identifier, or the like, which may be associated with any image, video, or scan of a package delivered to the delivery location, in some embodiments. The application may then determine that the package having the carrier transmitter device and the customer computing entity at the pick-up or delivery location are within a configurable distance from each other. As used herein, the carrier transmitter device that is associated with the package may also be referred to as a “package transmitter device.” The application may then monitor the package having the carrier transmitter device at the pick-up or delivery location, in embodiments. The application may detect that signals emitted from the carrier transmitter device directly, or indirectly through the customer computing entity (e.g., any “smart” home device, security camera), in some embodiments. The application may subsequently determine that the package having the carrier transmitter device and the customer computing entity are no longer within a configurable distance from each other, or that the package having the carrier transmitter device is traveling toward a boundary of the configurable distance (e.g., leaving the customer location). In response, application automatically generates and communicates a notification to an appropriate entity. In embodiments, the notification indicates an unauthorized removal of the package to the appropriate entity. In further embodiments, the application communicates with the customer computing entity by instructing the customer computing entity to initiate or perform an action, such as recording images, video, sound, and/or motion in order to document the unauthorized removal and catch the thief. In this way, the application may utilize the customer computing entity to capture information regarding the unauthorized removal of the package. The images, video, sound, motion, or the like may be communicated to one or more appropriate entities, as well. Unlike conventional technologies, embodiments of the invention herein utilize an application that interfaces with customer computing entities at a delivery location in order to detect, document, and alert customers of the unauthorized removal of the package after delivery.

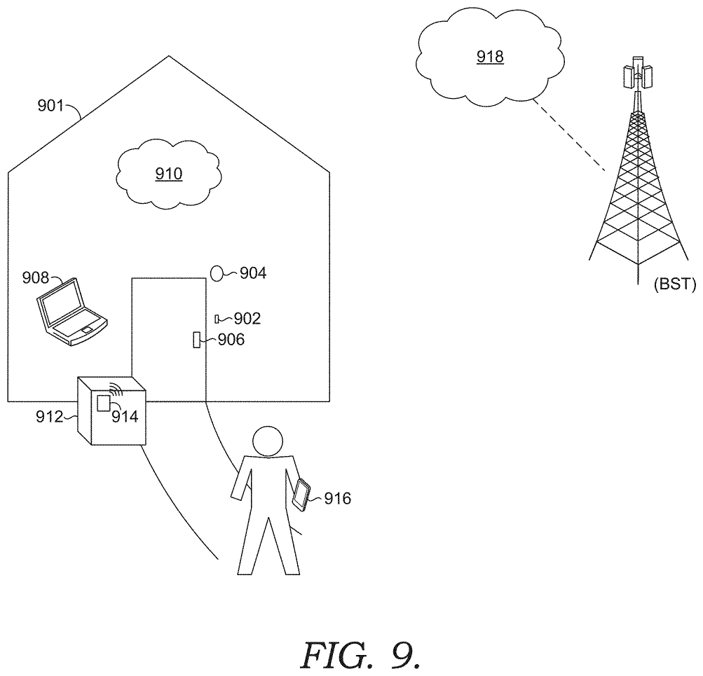

Turning to FIG. 9, an example environment 900 is shown for implementation of the embodiments herein. The example environment 900 corresponds to a delivery location 901, in some embodiments. In FIG. 9, the example environment 900 includes one or more customer computing entities, such as an electronic doorbell 902, an electronic security camera 904, an electronic locking mechanism 906 (e.g., “smart” door lock, keypad), and/or a personal computing device 908. The example environment 900 includes a wireless network 910 that interfaces with one or more of the customer computing entities in order to provide the customer computing entities, for example, access to the Internet, Internet-based services, streaming services, security applications, the other customer computing devices, and/or a mobile phone associated with the customer. The wireless network 910 may use any variety of protocols, such as Wi-Fi, WiMAX, UWB, IR protocols, NFC protocols, Bluetooth protocols, Wibree, HomeRF, SWAP, and/or any other wireless protocol (e.g., previously discussed for one or more networks 105). The wireless network 910 may be optionally secured, in some embodiments. In an embodiment, the wireless network 910 is secured and/or encrypted, in some embodiments. In various embodiments, connecting to the wireless network 910 may require a password, a token, and/or an authentication identifier that the wireless network 910 and/or the customer computing devices may use to authenticate and authorize another device to communicate via the wireless network 910.

In embodiments, delivery personnel may deliver a package 912 to the delivery location 901. The package 912 may be associated with a carrier transmitter device 914. In delivering the package 912 to the delivery location 901, for example, the delivery personnel may utilize a carrier computing entity (e.g., carrier computing entity 100) in the form of a portable device 916 and/or a delivery vehicle (not shown). Hereinafter, the terms “carrier computing entity” and “portable device” are used interchangeably. The portable device 916 may automatically, or based on user input, initiate a communication with the wireless network 910, in embodiments. Additionally, the portable device 916 may initiate a communication with one or more customer computing entities at the delivery location 901. The portable device 916 may initiate the communication with the wireless network 910 in order to activate monitoring of the package 912 via the carrier transmitter device 914, in various embodiments. The portable device 916 may automatically initiate the communication when the portable device 916 is within the wireless communications range of the wireless network 910, in one embodiment. In another embodiment, the portable device 916 may automatically initiate the communication when the portable device 916 determines that the portable device 916 is within or is approaching a predefined distance of the delivery location 901, for example, using GPS to identify the location of the portable device 916 relative to the delivery location 901 and/or a geofence. In one embodiment, the portable device 916 may automatically initiate the communication in response to the portable device 916 obtaining or receiving information from an image or an optical scan of a shipping label affixed to the package 912.

In embodiments, the portable device 916 communicates with the wireless network 910 in order to initiate authentication of the portable device 916 and to obtain authorization for the portable device 916 to connect with the wireless network 910. For example the portable device 916 may send a token, password, or authentication identifier to the wireless network 910, so that the wireless network 910 may determine whether the token, password, or authentication identifier matches a previously stored token, password, or authentication identifier. If there is a match, the portable device 916 is authenticated and authorized to connect to the wireless network 910. The token, password, or authentication identifier may be a predetermined authentication identifier that is agreed upon by the customer and a carrier for use in authenticating any number or kind of portable devices at any time prior to delivery of the package 912, in some embodiments. Additionally or alternatively, when the portable device 916 communicates with the wireless network 910, an application may send a push notification to a computing device such as a mobile device (not shown) of the customer over the wireless network 910 and/or via a telecommunications network 918. In one such example, the push notification requests that the customer provide approval of the connection of the portable device 916. Based on receipt of an affirmative response from the computing device of the customer, the portable device 916 may be authenticated and authorized to connect to the wireless network 910, in some embodiments. Additionally or alternatively, a carrier entity may send a message as an advance notice to the customer of an anticipated delivery. For example, a carrier entity may generate and send a text message “Your package arrives today!” or “Your shipment is out for delivery” to a computing device associated with the customer in advance of the scheduled delivery. The message may also request that the customer provide a token, password, or authentication identifier to the carrier in response to the message so that the token, password, or authentication identifier can be communicated to the portable device 916 in advance of, concurrent with, or at delivery of the package 912, in such embodiments. Additionally or alternatively, based on the portable device 916 communicating with the wireless network 910 in order to initiate authentication of the portable device 916 and to obtain authorization for the portable device 916 to connect with the wireless network 910, an application may trigger a customer computing entity to capture images, video, sound, or motion information at the delivery location. For example, by triggering the customer computing entity to capture data, one or more images, video, sound, or motion of delivery personnel may captured as the delivery personnel approaches or walks away from the delivery location after leaving the package. In one example, by triggering the customer computing entity to capture data, one or more images, video, sound, or motion of a delivery vehicle and/or delivery driver may be captured as approaching or leaving the delivery location after leaving the package. The data captured by the customer computing entity may serve as proof of delivery, for example, even when a package may not be within a field of view of a camera at the delivery location.

By obtaining authorization, the portable device 916 may communicate information for the package 912 over the wireless network 910 to a cloud-based application or service, an Internet-based application or service, the one or more customer computing devices, and/or to an application or service operating on the one or more customer computing devices. Receipt of the package information sent by the portable device 916 may be used to trigger the application or service to monitor the location of the package 912, in embodiments. The terms “application” and “service” may be used interchangeably herein to refer to computer program products as discussed (see e.g., “I. Computer Program Products, Methods, and Computing Entities”). In some embodiments, after a connection between the portable device 916 and the wireless network 910 is formed, the portable device 916 may communicate information such as an image of the package located at the delivery location to the application. In one such example, the information may act as a proof of delivery of the package. Additionally or alternatively, the information may include a package identifier, a shipping record identifier, a customer identifier, or the like, in embodiments. In another embodiment, the application may instruct one or more customer computing devices at the delivery location to use a sensor and/or camera to capture an image, video, or scan of the package 912 after the connection between the portable device 916 and the wireless network 910 is formed. The application may communicate the image, video, and/or scan obtained as information to a computing device associated with a customer, for example, to serve as proof of delivery. In one embodiment, the application may store an image, video, and/or scan of the package 912 captured at the delivery location, as obtained through one or more customer computing devices at the delivery location, in association with information received from the portable device 916 regarding the package 912.

In embodiments, the package 912 delivered to the delivery location 901 is within the wireless communications range of the wireless network 910. Accordingly, in some embodiments, an application that is accessible through the wireless network 910 acts to authorize the portable device 916 for connection to the wireless network 910 and obtains package information sent by the portable device 916. The application uses the package information that is encoded as electronic data to monitor the location of the package 912, in embodiments. The package information may include a unique identifier, in some embodiments. The unique identifier may specifically identify the package 912 that contains any number of items, one or more items within the package 912, a shipping record that is associated with the package 912, and/or a shipping record that is associated with one or more items in the package 912. Additionally or alternatively, the package information may also include information regarding the carrier transmitter device 914. For example, the information for the carrier transmitter device 914 may include a signal identifier or “signature” for the carrier transmitter device 914, may describe a signal protocol used by the carrier transmitter device 914, or other information enabling the application to recognize a signal transmitted from or broadcast by the carrier transmitter device 914.

In some embodiments, the carrier transmitter device 914 is physically attached to the package 912 that is within the wireless communications range of the wireless network 910. In some embodiments, the carrier transmitter device 914 is built into or constructed integrally with a package, enclosed within a package, attached to an item within a package, or the device may itself act as a container for holding the item for shipment, or the like. In one embodiment, the carrier transmitter device 914 is at least a portion of a shipping label that is physically attached to the package 912. For example, the carrier transmitter device 914 may be capable of communicating using any wireless protocol or a combination of wireless protocols (e.g., an integrated circuit chip, RFID tag, NFC, Bluetooth, and/or Wi-Fi) in order to communicate with other computing entities through the wireless network 910 or the telecommunications network 918. Such other computing entities might include a delivery vehicle, the portable device 916, and/or one or more customer computing entities. In some embodiments, the carrier transmitter device 914 is an RFID tag affixed to, or incorporated into, or placed inside, the package 912 (e.g., RFID tags 425). In some embodiments, the carrier transmitter device 914 is an RFID tag, and may be either an active RFID tag or a passive RFID tag. Generally, an active RFID tag includes an antenna for transmitting and receiving wireless signals, a processing element that acts as a control unit, one or more memory banks, and an integrated power source. A passive RFID tag generally includes an antenna for transmitting and receiving wireless signals, a processing element that acts as a control unit, and one or more memory banks. A passive RFID tag may rely on the antenna for capturing energy via the electromagnetic field produced by an external power supply. Although the term “tag” is used herein, the term is used for simplicity of description but the term “tag” should not be construed as limiting the embodiments herein. In some embodiments, the memory banks of the RFID tag may be used to store signal information, a signal identifier, and/or package information.

Using the package information communicated from the portable device 916, the application monitors the location of the package 912 that is within the wireless communications range of the wireless network 910. In embodiments, the application detects the signal that is transmitted or broadcast by the carrier transmitter device 914 that is affixed to or integrated with the package 912, either directly or indirectly. In some embodiments, one or more of the customer computing entities, such as electronic doorbell 902, electronic security camera 904, electronic locking mechanism 906 (i.e., a “smart” lock), and/or personal computing device 908 that are geographically located at the delivery location 901, may detect a wireless signal transmitted or broadcast by the carrier transmitter device 914. As such, the one or more of the customer computing entities may monitor the location of the package 912 relative to their own location, a geofence, the delivery location 901, or an edge of the wireless communications range, in various embodiments. In one embodiment, one or more of the customer computing entities detects the wireless signal transmitted or broadcast by the carrier transmitter device 914 and communicates an indication that confirms an affirmative detection of the package 912 to the application over the wireless network 910, such that the application is monitoring the package 912 via the one or more customer computing entities. In another embodiment, the application may directly detect the wireless signal transmitted or broadcast by the carrier transmitter device 914. Additionally or alternatively, the electronic doorbell 902, electronic security camera 904, electronic locking mechanism 906, the personal computing device 908, and/or the like, that are geographically located at the delivery location 901, may monitor the location and presence of the package 912 using one or more sensors that are configured to capture images, video, sound, and/or motion, for example. Images, video, sound, and/or motion captured via customer computing entities may be provided to the application that is responsible for monitoring the package 912 after delivery to the delivery location 901. For example, the electronic security camera 904 may send images periodically or may send streamed video to the application, where those images include an area of the delivery location 901 such as a porch, a stoop, an area in front of a door, or other physical place at the delivery location 901 where the package 912 may have been delivered. The electronic security camera 904, for example, may include a camera, may have a thermal or infrared sensor for capturing heat information, and/or may have night vision capabilities. In this way, the application may use the signal received from the carrier transmitter device 914 (i.e., either detected directly or via the customer computing entities) alone or in combination with additional information received from the customer computing entities such as images, video, sound, or motion as the application monitors the package 912. The application may use such additional information to confirm the location of the package 912. The additional information may be communicated to a customer and/or a carrier as evidence of delivery and/or as confirmation of the location. Any time subsequent to delivery of the package 912, the application may receive an indication from a customer (e.g., via one or more customer computing entities, a computing device or a mobile device associated with a customer, a customer profile for the customer) that the package 912 has been retrieved, which triggers the application to stop monitoring the location of the package 912.

In embodiments, the application monitors the carrier transmitter device 914 based on an electronic signal issued by the carrier transmitter device 914 on a regularly occurring a basis. Such a “ping” signal may be issued once at five second intervals, or once between a ten second interval, or any other interval. The signal interval may be configured and/or customized by the carrier entity or the application, in embodiments. In one embodiment, the application may measure the time interval that lapses between receipt of the signal issuances in order to learn the signal interval. In such an embodiment, the application recognizes that a signal is expected or anticipated to be received at the learned time/signal interval. Using this signal interval, the application may determine the location of the package 912 when the signals are regularly received, according to the measured time interval, in embodiments. Similarly, the application monitoring the package 912 may determine when there is a change or a loss of signal based on the signal interval, for example, when signals are not being received as expected. Based on the change or the loss of signal from the carrier transmitter device 914, the application may determine that the location of the package 912 is changing (e.g., the package 912 that was previously stationary after delivery is being moved, which indicates that someone or something is handling the package, possibly for theft) and/or that the package is no longer within the wireless communications range of the wireless network 910. If the application has not received an indication of package retrieval from the customer subsequent to the delivery of the package 912, the application may determine there has been an unauthorized removal of the package 912 based on the change detected with regard to the package 912 and based on the absence of any package retrieval indicator(s) from the customer.

Additionally or alternatively, the application may measure the signal strength of the signal from the carrier transmitter device 914 in order to determine a baseline signal strength. Based on the application's measurement or determination of the baseline signal strength, the application can determine when there is a decrease in signal strength, in some embodiments. The application may determine that the location of the package 912 is changing based on a decrease in signal strength, as the application recognizes that a weakening signal strength may be associated with a change in location that corresponds to increasing distance between the carrier transmitter device 914 and the delivery location 901, for example. If the application has not received an indication of package retrieval from the customer subsequent to the delivery of the package 912 to the delivery location 901, and the application determines that the location of the package 912 is changing and moving away from the delivery location 901, the application may determine an unauthorized removal of the package 912 may have occurred. For example, the application may determine that the location of the package 912 is approaching the edge of the wireless communication range based on the change in signal strength and/or location coordinates that pinpoint the location of the signal itself. Based on one or more the decreasing signal strength, a direction of the movement of the package 912 toward an edge of the wireless communication range of the wireless network 910 after delivery, or the absence of a customer package retrieval indicator, the application may predict that someone (e.g. something (e.g., an unmanned aerial vehicle or drone) is absconding with the package 912.

Accordingly, based on monitoring the package 912, the application can determine there has been an unauthorized removal of the package 912. For example, when the package 912 is determined not to be within the wireless communications range of the wireless network 910 after delivery of the package 912, the application determines that the package 912 is no longer located at the delivery location 901, in embodiments. As such, the application may predict that the package 912 is currently being stolen or has been stolen. In one embodiment, the application can determine when the package 912 is moving or approaching the edge of the wireless communications range of the wireless network 910, and based on this movement toward the edge, the application can predict that the package 912 is being stolen or spirited away. Additionally, in some embodiments, the application can determine when the package 912 is moving or approaching a virtual boundary or geofence associated with the delivery location 901, and based on this movement toward the boundary or geofence, the application can predict that the package 912 is being stolen.

When the application determines there has been an unauthorized removal of the package 912, the application generates an alert. The application may communicate the alert to a computing device, such as a mobile device, that is associated with the customer and/or an electronic destination address associated with the customer, for example, using one or more of the wireless network 910 or the telecommunications network 918. Additionally or alternatively, the application may communicate the alert to various entities, such as a law enforcement entity (e.g., New York Police Department, a home security entity such as ADT® Home Security) or service (e.g., SimpliSafe, Abode). In one embodiment, the application may communicate the alert to a customer and/or a predefined customer-provided contact regarding the unauthorized removal. For example, a customer can provide contact information for a device of another person within a customer profile or through the application who is to be contacted of the unauthorized removal of the package 912. (e.g., contact a neighbor whom may be able to visually inspect the delivery location 901, intercept the package, or catch a thief).

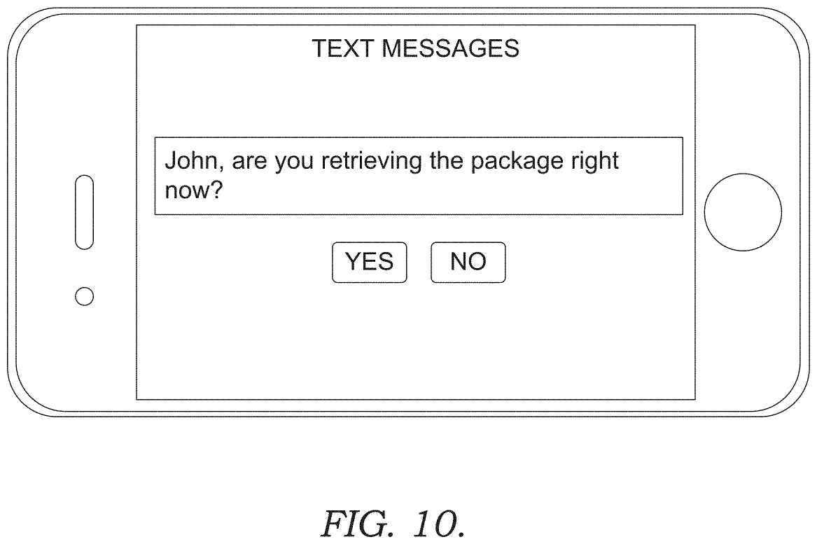

Additionally or alternatively, prior to communicating an alert to a law enforcement entity, the application may send an alert to a computing device or mobile device of a customer requesting that the customer confirm that they are not the person responsible for the movement of the package 912. The application may leverage any connection with the one or more customer computing entities, services associated with those customer computing entities (e.g., a web-based home security service that is associated with the electronic doorbell 902 and/or the electronic security camera 904 and/or the telecommunications network 918). The customer may provide an indication in response to the alert, wherein the indication indicates that either the customer is performing the package retrieval or is not, in embodiments. For example, as shown in FIG. 10, the alert may include a text and/or a voice message “Are you retrieving the package right now?” with selectable “Yes” and “No” options provided via graphical user interface or speakers of the computing device or mobile device, in order to elicit a selection or spoken confirmation from the customer. If the customer indicates that they are in the process of package retrieval (e.g., customer is taking the package away from the delivery location 901 but the customer forgot to send a package retrieval indication to the application), the application determines that an alert should not be communicated to a law enforcement entity. If the customer indicates they are not in the process of package retrieval, the application determines that an alert should be sent to a law enforcement entity. In this way, the application may prevent accidental or unnecessary alerts from being reported to a law enforcement entity. If the customer indicates they are not in the process of package retrieval, the application may determine that an alert should be sent to a predefined customer-provided contact regarding the unauthorized removal (e.g., customer can include contact information for a computing device or mobile device of another person, such as a neighbor, who will be alerted and may be able to intercede or catch the thief in the act).

In another embodiment, the application may instruct one or more customer computing devices at the delivery location to obtain an image, video, and/or scan of the package at the delivery location. The application may then compare the image, video, and/or scan obtained via the customer computing device(s) to a previously-captured image, video, and/or scan that was associated with a proof of delivery for the package, in an embodiment. The application may compare one or more images, videos, and/or scans to one another in order to identify any changes, for example, to determine whether the package does not appear to be present in a subsequently captured image, video, and/or scan relative to a previously-captured image, video, and/or scan that is associated with a proof of delivery. The application may compare images, videos, and/or scans in order to confirm that an unauthorized removal of the package has occurred. Similarly, the application may compare images, videos, and/or scans in order to determine that the package has not been removed, even though a signal from the carrier transmitter device may not be detected or is decreasing in strength.

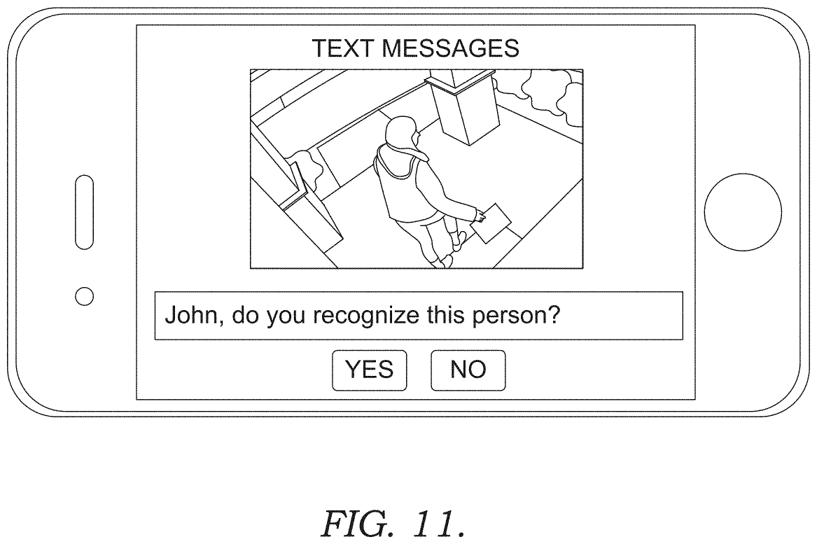

In embodiments, the alert may include images (e.g., color, black and white, false color), video (e.g., live stream), audio, thermal, and/or motion (e.g., motion sensor triggered, speed, acceleration) information captured as data by any of the customer computing entities. The data may encode images, video, audio, thermal, and/or motion information for an area near a delivery area, such as a front door, back door, garage, porch, carport, or other structural feature, that was recorded before (e.g., electronic doorbell 902 may have a motion sensor that is triggered by an approaching person and the electronic doorbell 902 begins recording image, video, and/or audio with a camera based on the motion sensor activation), during, and/or after the unauthorized removal of the package occurred. Because the application is communicatively coupled to the one or more customer computing entities as the delivery location, the application can access and use this data in the alert being generated. As such, images, video, or audio can be provided to the computing device or mobile device of the customer or a law enforcement agency. For example, as shown in FIG. 11, the alert may include a text message, an email, a voice message, a social media message, which queries “Do you recognize this person?” with selectable “Yes” and “No” options provided via a graphical user interface or a speaker, and may include display and/or playback of the images, video, motion, and/or audio information recorded. This allows the customer to provide a selection or a spoken confirmation regarding a case of identity. If the customer indicates that they or another person they recognize are present in the images, video, or audio (e.g., a helpful neighbor is moving the package to a back porch away from street view), the application determines that an alert should not be communicated to a law enforcement entity. If the customer indicates they do not recognize the person handling the package in the images, video, or audio, the application may determine that an alert should be sent to a law enforcement entity and/or a predefined customer-provided contact regarding the unauthorized removal of the package.

Accordingly, embodiments herein are capable of predicting unauthorized removal, documenting an unauthorized removal, and reporting an unauthorized removal to various entities, through various communication methods.

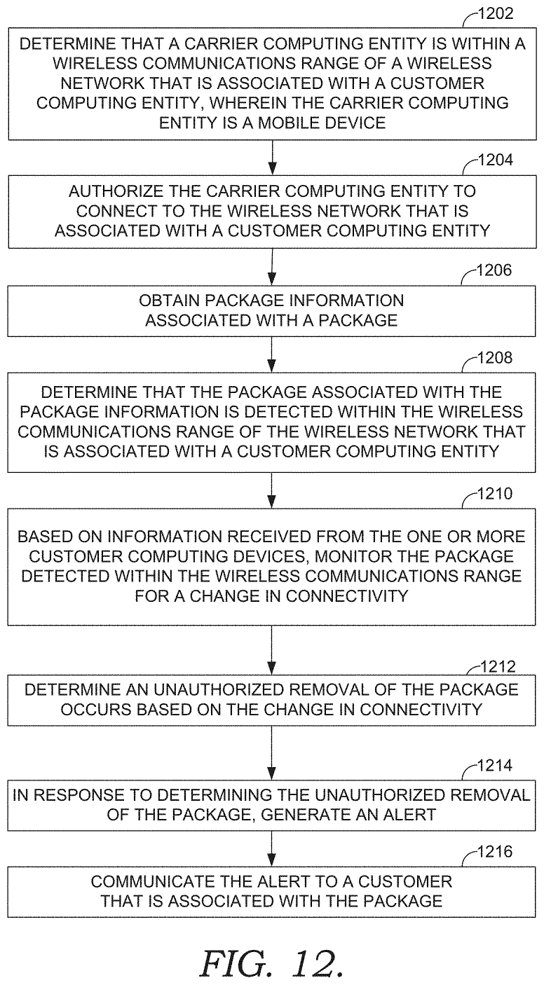

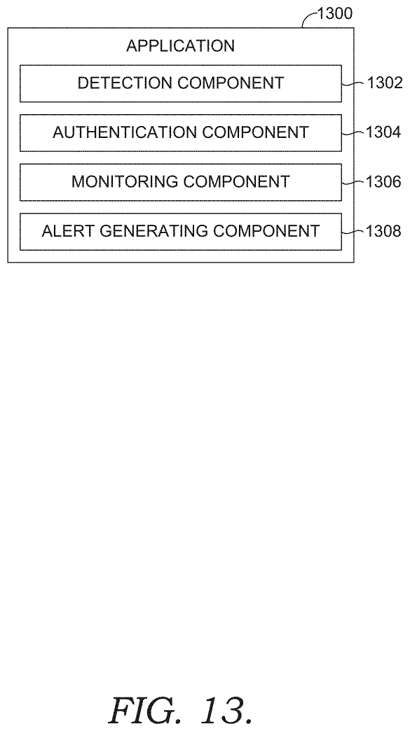

Continuing, FIG. 12 illustrates a method 1200 in accordance with an embodiment of the invention. The method 1200 may be a computer-implemented method, in some embodiments. In one embodiment, one or more non-transitory computer-readable storage medium having computer-readable program code portions embodied therein are used to implement the method 1200. For example, the computer-readable program code portions may include one or more executable portions configured to perform the method 1200, in an embodiment. The computer-readable program code may correspond to the application, described above, wherein the application performs the method 1200, in some embodiments. As further discussed below, the method 1200 may be performed using the application 1300 and application components shown in FIG. 13.

At block 1202, the application 1300 determines that a carrier computing entity is within a wireless communications range of a wireless network that is associated with a customer computing entity, wherein the carrier computing entity is a mobile device. For example, a carrier computing entity such as a portable device is detected at a delivery stop when a package is being delivered to the delivery stop and, for example, the portable device is being carried by the delivery personnel performing delivery. In embodiments, a detection component 1302 associated with the application 1300 may determine that a carrier computing entity/portable device is detected when the portable device is within the wireless range of the wireless network at the delivery location. One or more customer computing entities (e.g., an electronic doorbell, a security camera for recording images, video, and/or audio, a motion sensor, and/or an electronic locking mechanism) may be located at the delivery location or associated with the delivery location (e.g., a customer's residence or location defined for delivery to that particular customer). Accordingly, the detection component 1302 may leverage data received from a customer computing entity at the delivery location when detecting a carrier computing entity/portable device. For example, the detection component 1302 may obtain images, video, audio, and/or motion data captured by a customer computing entity and use this information to determine that the carrier computing entity/portable device is detected within the wireless communications range. Additionally or alternatively, the detection component 1302 may determine that the carrier computing entity/portable device has initiated or sent a communication to the application 1300, for example, an electronic request for the application 1300. For example, the communication may be a request to authenticate and authorize the carrier computing entity/portable device to use and communicate through the wireless network.

At block 1204, the application 1300 may authorize the carrier computing entity/portable device to connect to the wireless network that is associated with the customer computing entity. In embodiments, an authentication component 1304 associated with the application 1300 may perform authorization of the carrier computing entity/portable device to connect to the wireless network. For example, the authentication component 1304 may receive a communication including a password, token, and/or authentication identifier from the portable device and authorize the portable device based on the password, token, and/or authentication identifier in that communication. The communication may be transmitted from the portable device to the application 1300 using any wireless protocol as previously discussed herein. For example, the authentication component 1304 may obtain a communication that includes an authentication identifier for authorizing the carrier computing entity/portable device to connect to the wireless network and/or a customer computing entity at the delivery location.

In one example, the authentication component 1304 obtains an authentication identifier based on receipt of shipping label information corresponding to the package. For example, shipping label information may be sent to the application 1300 by the carrier computing entity/portable device (e.g., device that optically scans the shipping label and communicates the information of the shipping label as data to the application 1300) and/or by a customer computing entity (e.g., a security camera obtains an image of the shipping label attached to the package being delivered to the front door at the delivery location and communicates the information of the shipping label as data to the application 1300). In some embodiments, the shipping label information acts as an authentication identifier for the carrier computing entity/portable device, and further enables the application 1300 to compare the shipping label information to a shipping record that corresponds to a scheduled or anticipated delivery associated with the package. By comparison, the authentication component 1304 may determine that the shipping label information matches an anticipated package delivery, and based on this affirmative match, the carrier computing entity/portable device may be authorized to connect to the wireless device, in an embodiment. As such, the carrier computing entity/portable device may be authorized to connect to the wireless network responsive to determining that the package is anticipated for delivery based on the package information and/or shipping label information, in some embodiments.

Additionally or alternatively, the authentication component 1304 may obtain a predetermined authentication identifier that is associated with the package prior to detection of the carrier computing entity/portable device and/or the package. For example, a predetermined authentication identifier that is associated with the carrier computing entity/portable device and/or the package is generated by a carrier, a customer, or a user prior to detection of the package. The predetermined authentication identifier may be provided, in advance or concurrent to delivery, to the carrier computing entity/portable device for delivery of the particular package to the specific delivery location and/or to the application 1300 so that the application 1300 can authenticate the carrier computing entity/portable device and authorize connection to the wireless network. The application 1300 may thus facilitate a connection of the carrier computing entity/portable device to the wireless network that is associated with a customer computing entity. Additionally or alternatively, the authentication identifier may be communicated to a customer computing entity for authentication, for example, so that the carrier computing entity/portable device may connect directly to the customer computing entity. In such embodiments, the application 1300 and/or the authentication component 1304 may receive a notification from the carrier computing entity/portable device confirming authorization of the authentication identifier.

At block 1206, the application 1300 may obtain package information associated with a package in accordance with the method 1200. The package information may be received from the carrier computing entity/portable device, a customer computing entity, a customer profile, and/or shipping record generated by a carrier entity, for example. In some embodiments, the carrier computing entity/portable device communicates package information to the application 1300. The package information may be transmitted before, during, or after the carrier computing entity/portable device is authorized to connect to the wireless network, in various embodiments. In one example, the package information is obtained by the application 1300 with the initial communication from the carrier computing entity/portable device seeking or requesting authorization to connect to the wireless network. In another example, the package information is obtained by the application 1300 after the authorization of the portable device. Sending the package information subsequent to authorization may beneficially protect the privacy of a customer associated with the package, in some embodiments. To illustrate, if the package information includes sensitive information that identifies an item in the package, identifies a customer, identifies an electronic address (e.g., email or telephone number) of a customer, or identifies a residence of a customer, waiting for authorization before sending the package information prevents the unintended disclosure of the package information over an unsecured or public wireless network that overlaps the range of the wireless network at the intended delivery location, or the unintended disclosure to an application at an incorrect delivery location, for example. Similarly, when the package information includes sensitive information, waiting for authorization of the computing entity/portable device using a predetermined authentication identifier that has been provided to the application 1300 in advance of delivery ensures that the computing entity/portable device provides the package information to the application 1300 at the intended delivery location.

The package information may include a unique identifier for the package, an item in the package, a shipping record associated with the package and/or item. Additionally or alternatively, the package information includes signal information (e.g., a radio-frequency or frequency range, defined time interval(s) for signal emissions, a time interval pattern for signal emissions, a baseline signal strength) and/or a unique signal signature that identifies a carrier transmitter device affixed to the package. For example, the package information may describe a signal protocol used by the carrier transmitter device or other information enabling the application 1300 to recognize a signal transmitted from or broadcast by the carrier transmitter device that is within the wireless communications range of the wireless network at the delivery location.

At block 1208, the application 1300 determines that the package associated with the package information is detected within the wireless communications range of the wireless network that is associated with a customer computing entity. The detection component 1302 may use the package information, in some embodiments, to determine and detect, recognize, and locate a carrier transmitter device affixed to or co-located with the package. The detection component 1302 may leverage the wireless network at the delivery location, one or more customer computing entities at the delivery location, and/or a telecommunications network in order to locate the package, using GPS coordinates, a signal transmitted from a carrier transmitter device of the package, and/or images and video captured at the delivery location. Once the package is detected, the detection component 1302 may provide the package information to a monitoring component 1306 of the application.

At block 1210, the application 1300 may, based on information received from the one or more customer computing devices, monitor the package for a change in connectivity. In some embodiments, the monitoring component 1306 of the application 1300 monitors the package for a change in connectivity, for example, to determine whether the package is or is not within the wireless communications range of the wireless network. The monitoring component 1306 may include logic for assessing signal “pings” from the carrier transmitter device of the package in a real-time, on-going, or continuous manner. The monitoring component 1306 may include memory for storing signal information that was received after initial detection of the package, such as the timing of intervals between signals (e.g., time between each ping), a baseline signal strength, a signal strength of each signal received, and the like. The monitoring component 1306 may use its stored information of the signals received from the carrier transmitter device to identify changes in connectivity such as fluctuations in a signal timing interval, changes in signal strength over time, or even a change in the unique signal signature, in some examples. Additionally or alternatively, the monitoring component 1306 may use its stored information (e.g., from prior signals as measured by the monitoring component 1306), current signal information, the package information, images and/or video captured by customer computing entities at the delivery location, GPS information, and/or location information received over a telecommunications network, in order to locate the package, identify changes in location of the package, and to identify a direction, speed, acceleration, or magnitude of package movement in order to track the location of the package. The monitoring component 1306 may use any wireless protocols discussed herein in monitoring the package, in various embodiments.

In some embodiments, the monitoring component 1306 may monitor the package by receiving one or more indications that specify whether the package is within the wireless communications range of the wireless network that is associated with the customer computing entity, wherein the one or more indications are indicators of connectivity. The indications may be the signal itself from the carrier transmitter device or, alternatively, indications from one or more customer computing entities that are detecting the package itself through images or video and/or the carrier transmitter device's signal, for example. In some embodiments, the monitoring component 1306 may leverage images or video received via one or more customer carrier entities to confirm the connectivity and/or location of the package, for example, when a signal from the carrier transmitter device of the package is not detected, is intermittently detected (e.g., no reliable or strong signals), or when the strength of the signal decreases or is decreasing.

At block 1212, the application 1300 may determine there has been an unauthorized removal based on a change in connectivity. In some embodiments, the monitoring component 1306 may determine an unauthorized removal of the package when there is a change in connectivity that indicates the package is not detected within the wireless communications range of the wireless network that is associated with a customer computing entity. For example, based on the monitoring, an unauthorized removal of the package may be predicted by the application 1300 when there is a change in connectivity that indicates the wireless signal associated with the package has not been detected within the wireless communications range of the wireless network for a defined period of time. In some embodiments, a threshold signal strength may be used to determine whether a signal is detected (e.g., a signal is detected but the strength of the signal is at below a threshold such that the application treats the signal as being lost of absent due to the weakness in strength). In another example, based on the monitoring of the package for a change in connectivity, an unauthorized removal of the package may be predicted by the application 1300 when a signal strength of the wireless signal associated with the package within the wireless communications range of the wireless network is decreasing over the defined period of time. In one example, based on the monitoring, an unauthorized removal of the package may be predicted by the application 1300 when a change in connectivity indicates that the wireless signal associated with the package within the wireless communications range of the wireless network is intermittently detected within the wireless communications range over the defined period of time. In some embodiments, the monitoring component 1306 may leverage images or video from one or more customer computing devices at the delivery location to verify that the package is no longer at the delivery location or that the package is moving away from the delivery location.

At block 1214, in response to determining that there has been an unauthorized removal of the package, the application 1300 generates an alert. Further, at block 1216, the application 1300 communicates the alert to an entity, such as a customer that is associated with the package or a law enforcement entity. In some embodiments, an alert generating component 1308 generates and communicates the alert to an entity such as a customer that is associated with the package or a law enforcement entity. Accordingly, when the application 1300 determines there has been an unauthorized removal of the package 912, the alert generating component 1308 may generate and communicate the alert to a computing device or mobile device associated with the customer and/or an electronic destination address associated with the customer, for example, using the wireless network and/or the telecommunications network. Additionally or alternatively, the alert generating component 1308 may communicate the alert to various entities, such as a law enforcement entity (e.g., New York Police Department, a home security entity such as ADT® Home Security), and/or another application (e.g., SimpliSafe, Abode). In one embodiment, the alert generating component 1308 may communicate the alert to a customer and a predefined customer-provided contact regarding the unauthorized removal of the package (e.g., customer can include contact information for a computing device or mobile device of another person, such as a neighbor, who will be alerted and may be able to intercede or catch the thief in the act).

Additionally or alternatively, prior to communicating an alert to a law enforcement entity, the alert generating component 1308 may send an alert to a computing device or mobile device of a customer requesting that the customer confirm that they are not the person responsible for the movement of the package, for example, as discussed with regard to the examples shown in FIGS. 10 and 11. As such, when the application 1300 has not received an indication from the customer that the package is or has been retrieved by the customer subsequent to the package's delivery, the alert generating component 1308 may determine whether or not to send an alert of the unauthorized removal of the package to the customer, a law enforcement entity, a carrier, and/or a customer-provided contact, as previously discussed with regard to FIG. 9.

### V. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A non-transitory computer program product comprising computer-readable storage medium having computer-readable program code portions embodied therein, the computer-readable program code portions comprising:
one or more executable portions configured to:
determine that a carrier computing entity is within a wireless communications range of a wireless network that is associated with a customer computing entity, wherein the carrier computing entity is a mobile device;
authorize the carrier computing entity to connect to the wireless network that is associated with a customer computing entity;
obtain package information associated with a package;
determine that the package associated with the package information is detected within the wireless communications range of the wireless network that is associated with a customer computing entity;
based on information received from the one or more customer computing devices, monitor the package detected within the wireless communications range for a change in connectivity;
determine an unauthorized removal of the package occurs based on the change in connectivity;
in response to determining the unauthorized removal of the package, generate an alert; and
communicate the alert to a customer that is associated with the package.

2. The computer program product of claim 1, wherein the one or more executable portions are configured to obtain an authentication identifier that authorizes the carrier computing entity to connect to one or more of the wireless network or the customer computing entity.

3. The computer program product of claim 1, wherein the one or more executable portions are configured to obtain an authentication identifier based on receipt of label information corresponding to the package, the label information provided via the carrier computing entity.

4. The computer program product of claim 1, wherein the one or more executable portions are configured to obtain a predetermined authentication identifier that is associated with the package prior to detection of the package.

5. The computer program product of claim 4, wherein the predetermined authentication identifier that is associated with the package is generated by a carrier, a customer, or a user prior to detection of the package.

6. The computer program product of claim 1, wherein the one or more executable portions are configured to:
obtain an authentication identifier for facilitating a connection of the carrier computing entity to the wireless network that is associated with a customer computing entity;
communicate the authentication identifier obtained to the customer computing entity for authentication;
receive a notification from the customer computing entity that confirms authorization of the authentication identifier;
facilitate a connection of the carrier computing entity with the wireless network that is associated with a customer computing entity; and
initiate monitoring of the package subsequent to the connection of the carrier computing entity with the wireless network.

7. The computer program product of claim 1, wherein the change in connectivity is detected when at least one of:
a wireless signal associated with the package is not detected within the wireless communications range of the wireless network that is associated with a customer computing entity for a defined period of time;
a signal strength of the wireless signal associated with the package within the wireless communications range of the wireless network that is associated with a customer computing entity is decreasing over the defined period of time; or
the wireless signal associated with the package within the wireless communications range of the wireless network that is associated with a customer computing entity is intermittently detected within the wireless communications range of the customer computing entity over the defined period of time.

8. The computer program product of claim 1, wherein the carrier computing entity is authorized to connect to the wireless network responsive to determining, using the package information, that the package is anticipated for delivery.

9. The computer program product of claim 1, wherein the one or more executable portions are configured to monitor the package by receiving one or more indications that specify whether the package is within the wireless communications range of the wireless network that is associated with the customer computing entity.

10. The computer program product of claim 9, wherein the one or more indications are received from the customer computing entity.

11. A computer-implemented method, the method comprising:
determining that a carrier computing entity is within a wireless communications range of a wireless network that is associated with a customer computing entity, wherein the carrier computing entity is a mobile device;
authorizing the carrier computing entity to connect to the wireless network by obtaining an authentication identifier from the carrier computing entity;
connecting the carrier computing entity and wireless network that is associated with a customer computing entity based on authorizing the authentication identifier;
obtaining package information from one or more of the carrier computing entity or the customer computing entity;
determining that a package associated with the package information is detected within the wireless communications range of the wireless network that is associated with a customer computing entity;
based on information received from the one or more customer computing devices, monitoring the package detected within the wireless communications range of the wireless network for a change in connectivity;
determining an unauthorized removal of the package when the change is detected based on monitoring the package;
in response to determining the unauthorized removal of the package, generating an alert; and
communicating the alert to a customer that is associated with the package.

12. The method of claim 11, wherein the customer computing entity includes one or more devices, the one or more devices including at least one of a camera, a thermal sensor, an infrared sensor, an audio sensor, or a motion sensor configured to monitor a delivery location associated with a particular customer.

13. The method of claim 11, wherein determining that the carrier computing entity is within the wireless communications range of the wireless network comprises receiving an indication from the customer computing entity that the carrier computing entity is detected within the wireless communications range via one or more sensors communicatively coupled to the carrier computing entity.

14. The method of claim 11, wherein the package is automatically monitored responsive to receiving an instruction from the carrier computing entity to initiate monitoring the package.

15. The method of claim 11, wherein the package is automatically monitored responsive to receiving an instruction from the customer computing entity to initiate monitoring the package.

16. The method of claim 11, wherein the package is automatically monitored responsive to determining that the package associated with the package information is within the wireless communications range of the wireless network.

17. The method of claim 11, further comprising connecting the carrier computing entity to the customer computing entity based on authorizing the authentication identifier.

18. The method of claim 11, wherein determining the unauthorized removal of the package based on the change in connectivity comprises determining that:
a wireless signal associated with the package is not detected within the wireless communications range of the wireless network that is associated with a customer computing entity for a defined period of time;
a signal strength of the wireless signal associated with the package within the wireless communications range of the wireless network that is associated with a customer computing entity is decreasing over the defined period of time; or
the wireless signal associated with the package within the wireless communications range of the wireless network that is associated with a customer computing entity is intermittently detected within the wireless communications range of the customer computing entity over the defined period of time.

19. The method of claim 11, wherein the carrier computing entity is authorized to connect to the wireless network responsive to determining, using the package information, that the package is anticipated for delivery.

20. A system comprising:
a carrier transmitter device; and
an application executed by one or more processors, the application performing:
based on information received via a customer computing entity, determining that a carrier computing entity is within a wireless communications range of a wireless network associated with a customer computing entity, wherein the carrier computing entity is a portable device;
obtaining an authentication identifier from the carrier computing entity that authorizes the carrier computing entity to connect to the wireless network associated with the customer computing entity:
authorizing the carrier computing entity to connect to the wireless network based on the authentication identifier;
obtaining package information from the carrier computing entity, the package information identifying the package and identify an RFID tag affixed to the package;
determining that the package associated with the package information is detected within the wireless communications range of the wireless network based on detection of the RFID tag affixed to the package by the customer computing entity;
based on information received from the one or more customer computing devices, monitoring the package detected within the wireless communications range of the wireless network for a change in connectivity;
determining an unauthorized removal of the package when a change is detected based on the monitoring of the package;
in response to determining the unauthorized removal of the package, generating an alert, the alert indicating the unauthorized removal of the package; and
communicating the alert to a customer that is associated with the package.
